(19) United States
(12) Patent Application Publication
(10) Pub. No.: US 2026/0331072 A1
(43) Pub. Date: Oct. 22, 2026

(54) DISPLAY DEVICE AND DRIVING METHOD THEREOF

(71) Applicant: TCL China Star Optoelectronics Technology Co., Ltd., Shenzhen (CN)

(72) Inventors: Donghun LIM, Shenzhen (CN); Zelin YANG, Shenzhen (CN); Miao LIN, Shenzhen (CN); Chungching HSIEH, Shenzhen (CN); He WANG, Shenzhen (CN)

(73) Assignee: TCL China Star Optoelectronics Technology Co., Ltd., Shenzhen (CN)

(21) Appl. No.: 19/704,483

(22) Filed: Jun. 11, 2026

(30) Foreign Application Priority Data
Dec. 15, 2025 (CN) 202511897187.4

(51) Int. Cl. G09G 3/36

(52) U.S. Cl. CPC G09G 3/3677; G09G 2300/0408; G09G 2300/0426

(57) ABSTRACT

A display device and a driving method thereof are provided. The display device includes N stages of gate driving units and 2N rows of pixel units, and an i-th stage of gate driving unit is electrically connected to gate lines of a (2i−1)-th row and a 2i-th row of pixel units. The i-th stage of gate driving unit includes a first and a second transistors, gates of the first and second transistor are both electrically connected to the first node, one of a source and a drain of the first transistor is electrically connected to a first clock signal line, and the other is electrically connected to a first gate driving signal output terminal; one of a source and a drain of the second transistor is electrically connected to a second clock signal line, and the other is electrically connected to a second gate driving signal output terminal.

### RELATED APPLICATION

This application claims the benefit of priority of Chinese Patent Application No. 202511897187.4 filed on Dec. 15, 2025. The contents of the above application is all incorporated by reference as if fully set forth herein in their entirety.

### TECHNICAL FIELD

The present disclosure relates to the field of display technologies, and in particular, to a display device and a driving method thereof.

### BACKGROUND

Gate driving circuits (Gate-driver on array, GOA) are widely used in display panels for providing gate driving signals to pixel units. The traditional gate driving circuit includes a plurality of stages of cascaded gate driving units, the gate driving unit at each stage generally includes functional modules such as a pull-up control module, a pull-up module, a pull-down module, a pull-down maintaining module, and a reset module, and each functional module is composed of a plurality of thin film transistors. The traditional gate driving unit at each stage outputs a gate driving signal for one row, and the gate driving unit at one stage usually requires more than 16 thin film transistors to realize the function of outputting the gate driving signal. A high-reliability gate driving unit even requires more than 20 thin film transistors.

An occupied area of the gate driving circuit directly affects a frame width of the display panel, and a number of the thin film transistors in the gate driving unit is one of the key factors affecting a width of the gate driving circuit. The traditional gate driving unit has a large overall width due to the large number of thin film transistors, which makes the gate driving circuit difficult to meet the requirements of narrow frame display panels.

Therefore, it is necessary to propose a new technical solution to solve the above technical problems.

### SUMMARY

The present disclosure provides a display device, the display device includes a display panel, and the display panel includes at least one gate driving circuit and a plurality of pixel units. The plurality of pixel units includes 2N rows of pixel units, and the gate driving circuit includes N stages of gate driving units. An i-th stage of gate driving unit is electrically connected to a gate line of a (2i−1)-th row of pixel units and a gate line of a 2i-th row of pixel units. The i-th stage of gate driving unit includes: a pull-up control unit configured to control a potential of a first node; a pull-up unit including a first transistor and a second transistor, where a gate of the first transistor is electrically connected to the first node, one of a source and a drain of the first transistor is electrically connected to a first clock signal line, another one of the source and the drain of the first transistor is electrically connected to a first gate driving signal output terminal, a gate of the second transistor is electrically connected to the first node, one of a source and a drain of the second transistor is electrically connected to a second clock signal line, and another one of the source and the drain of the second transistor is electrically connected to a second gate driving signal output terminal; and a pull-down maintaining unit including at least two inverters, where the inverters are electrically connected to a stage-transmission signal output terminal of the i-th stage of gate driving unit, the first node, the first gate driving signal output terminal, and the second gate driving signal output terminal; and where i and N are positive integers, and i are less than or equal to N.

The present disclosure also provides a driving method of a display device, the display device includes a display panel, the display panel includes at least one gate driving circuit and a plurality of pixel units, the plurality of pixel units include 2N rows of pixel units, the gate driving circuit includes N stages of gate driving units, and an i-th stage of gate driving unit is electrically connected to a gate line of a (2i−1)-th row of pixel units and a gate line of a 2i-th row of pixel units; the i-th stage of gate driving unit includes a pull-up unit, the pull-up unit includes a first transistor and a second transistor, a gate of the first transistor and a gate of the second transistor are both electrically connected to a first node, one of a source and a drain of the first transistor is electrically connected to a first clock signal line, another one of the source and the drain of the first transistor is electrically connected to a first gate driving signal output terminal, one of a source and a drain of the second transistor is electrically connected to a second clock signal line, and another one of the source and the drain of the second transistor is electrically connected to a second gate driving signal output terminal; the driving method includes that: when the first node is in a high-potential state, the first transistor is turned on, a first clock signal transmitted by the first clock signal line is transmitted to the first gate driving signal output terminal through the first transistor, the second transistor is turned on, a second clock signal transmitted by the second clock signal line is transmitted to the second gate driving signal output terminal through the second transistor, and an output time of an effective level of the first clock signal is different from an output time of an effective level of the second clock signal; where i and N are positive integers, and i is less than or equal to N.

### BRIEF DESCRIPTION OF DRAWINGS

FIG. 1 is a schematic diagram of a display device provided in embodiments of the present disclosure.

FIG. 2 is a circuit diagram of an i-th stage of gate driving unit in a gate driving circuit of a display device provided in embodiments of the present disclosure.

FIG. 3 is a waveform diagram of related signals of an i-th stage of gate driving unit in a gate driving circuit of a display device provided in embodiments of the present disclosure.

### DETAILED DESCRIPTION

The following describes specific implementations of the present disclosure in detail with reference to the accompanying drawings.

The terms “first”, “second”, and the like do not denote any order, quantity, or importance, but rather are used to distinguish one technical feature from another. The term “plurality of” and similar terms mean two or more, unless otherwise expressly defined.

An objective of the present disclosure is to provide a display device and a driving method thereof, aiming to reduce an occupied area of a gate driving circuit and meet a requirement of a narrow frame display panel.

The present disclosure provides a display device, the display device includes a display panel, and the display panel includes at least one gate driving circuit and a plurality of pixel units. The plurality of pixel units include 2N rows of pixel units, and the gate driving circuit includes N stages of gate driving units. An i-th stage of gate driving unit is electrically connected to a gate line of a (2i−1)-th row of pixel units and a gate line of a 2i-th row of pixel units. The i-th stage of gate driving unit includes: a pull-up control unit configured to control a potential of a first node; a pull-up unit including a first transistor and a second transistor, where a gate of the first transistor is electrically connected to the first node, one of a source and a drain of the first transistor is electrically connected to a first clock signal line, another one of the source and the drain of the first transistor is electrically connected to a first gate driving signal output terminal, a gate of the second transistor is electrically connected to the first node, one of a source and a drain of the second transistor is electrically connected to a second clock signal line, and another one of the source and the drain of the second transistor is electrically connected to a second gate driving signal output terminal; and a pull-down maintaining unit including at least two inverters, where the inverters are electrically connected to a stage-transmission signal output terminal of the i-th stage of gate driving unit, the first node, the first gate driving signal output terminal, and the second gate driving signal output terminal; and where i and N are positive integers, and i are less than or equal to N.

In the above display device, the pull-up control unit includes a third transistor, a gate of the third transistor is electrically connected to a stage-transmission signal output terminal of an (i−x)-th stage of gate driving unit, one of a source and a drain of the third transistor is electrically connected to a first power signal line or the stage-transmission signal output terminal of the (i−x)-th stage of gate driving unit, and another one of the source and the drain of the third transistor is electrically connected to the first node; where x is a positive integer.

In the above display device, x is half of a number of clock signal lines of the gate driving circuit.

In the above display device, the pull-up unit further includes a fourth transistor, a gate of the fourth transistor is electrically connected to the first node, one of a source and a drain of the fourth transistor is electrically connected to the first clock signal line, and another one of the source and the drain of the fourth transistor is electrically connected to the stage-transmission signal output terminal of the i-th stage of gate driving unit.

In the above display device, the i-th stage of gate driving unit further includes a reset unit; the reset unit includes a fifth transistor, a sixth transistor, a seventh transistor, and an eighth transistor; a gate of the fifth transistor is electrically connected to a reset control signal line, one of a source and a drain of the fifth transistor is electrically connected to a second power signal line, and another one of the source and the drain of the fifth transistor is electrically connected to the first node; a gate of the sixth transistor is electrically connected to the reset control signal line, one of a source and a drain of the sixth transistor is electrically connected to the second power signal line, and another one of the source and the drain of the sixth transistor is electrically connected to the stage-transmission signal output terminal of the i-th stage of gate driving unit; a gate of the seventh transistor is electrically connected to the reset control signal line, one of a source and a drain of the seventh transistor is electrically connected to a third power signal line, and another one of the source and the drain of the seventh transistor is electrically connected to the first gate driving signal output terminal; and a gate of the eighth transistor is electrically connected to the reset control signal line, one of a source and a drain of the eighth transistor is electrically connected to the third power signal line, and another one of the source and the drain of the eighth transistor is electrically connected to the second gate driving signal output terminal.

In the above display device, the i-th stage of gate driving unit further includes a pull-down unit, the pull-down unit includes a ninth transistor, a gate of the ninth transistor is electrically connected to a stage-transmission signal output terminal of an (i+y)-th stage of gate driving unit, one of a source and a drain of the ninth transistor is electrically connected to a second power signal line, and another one of the source and the drain of the ninth transistor is electrically connected to the first node; where y is a positive integer.

In the above display device, the at least two inverters include a first inverter and a second inverter, each of the first inverter and the second inverter includes a plurality of transistors electrically connected to stage-transmission signal output terminals at different stages, a width of an effective pulse of any one of stage transmission signals output by the stage-transmission signal output terminals at different stages is less than a width of an effective pulse of a signal transmitted by the first node, and a sum of widths of effective pulses of the stage transmission signals output by the stage-transmission signal output terminals at different stages is greater than the width of the effective pulse of the signal transmitted by the first node.

In the above display device, the first inverter includes a tenth transistor, an eleventh transistor, a twelfth transistor, a thirteenth transistor, a fourteenth transistor, a fifteenth transistor, and a sixteenth transistor; the pull-down maintaining unit further includes a seventeenth transistor, an eighteenth transistor, a nineteenth transistor, and a twentieth transistor; a gate of the tenth transistor is electrically connected to a first control signal line, one of a source and a drain of the tenth transistor is electrically connected to the first control signal line, and another one of the source and the drain of the tenth transistor is electrically connected to a second node; a gate of the eleventh transistor is electrically connected to a second control signal line, one of a source and a drain of the eleventh transistor is electrically connected to a second power signal line, and another one of the source and the drain of the eleventh transistor is electrically connected to the second node; a gate of the twelfth transistor is electrically connected to a stage-transmission signal output terminal of an (i-a)-th stage of gate driving unit, one of a source and a drain of the twelfth transistor is electrically connected to the second power signal line, and another one of the source and the drain of the twelfth transistor is electrically connected to the second node; a gate of the thirteenth transistor is electrically connected to a stage-transmission signal output terminal of an (i-b)-th stage of gate driving unit, one of a source and a drain of the thirteenth transistor is electrically connected to the second power signal line, and another one of the source and the drain of the thirteenth transistor is electrically connected to the second node; a gate of the fourteenth transistor is electrically connected to the stage-transmission signal output terminal of the i-th stage of gate driving unit, one of a source and a drain of the fourteenth transistor is electrically connected to the second power signal line, and another one of the source and the drain of the fourteenth transistor is electrically connected to the second node; a gate of the fifteenth transistor is electrically connected to a stage-transmission signal output terminal of an (i+c)-th stage of gate driving unit, one of a source and a drain of the fifteenth transistor is electrically connected to the second power signal line, and another one of the source and the drain of the fifteenth transistor is electrically connected to the second node; a gate of the sixteenth transistor is electrically connected to the first node, one of a source and a drain of the sixteenth transistor is electrically connected to the second power signal line, and another one of the source and the drain of the sixteenth transistor is electrically connected to the second node; a gate of the seventeenth transistor is electrically connected to the second node, one of a source and a drain of the seventeenth transistor is electrically connected to a third power signal line, and another one of the source and the drain of the seventeenth transistor is electrically connected to the first gate driving signal output terminal; a gate of the eighteenth transistor is electrically connected to the second node, a source and a drain of the eighteenth transistor is electrically connected to the second power signal line, and another one of the source and the drain of the eighteenth transistor is electrically connected to the stage-transmission signal output terminal of the i-th stage of gate driving unit; a gate of the nineteenth transistor is electrically connected to the second node, one of a source and a drain of the nineteenth transistor is electrically connected to the second power signal line, and another one of the source and the drain of the nineteenth transistor is electrically connected to the first node; and a gate of the twentieth transistor is electrically connected to the second node, one of a source and a drain of the twentieth transistor is electrically connected to the third power signal line, and another one of the source and the drain of the twentieth transistor is electrically connected to the second gate driving signal output terminal; where a, b, and c are positive integers.

In the above display device, channel widths of the twelfth transistor, the thirteenth transistor, the fourteenth transistor, the fifteenth transistor, and the sixteenth transistor are greater than a channel width of the eleventh transistor, and the channel width of the eleventh transistor is greater than a channel width of the tenth transistor.

In the above display device, the second inverter includes a twenty-first transistor, a twenty-second transistor, a twenty-third transistor, a twenty-fourth transistor, a twenty-fifth transistor, a twenty-sixth transistor, and a twenty-seventh transistor; the pull-down maintaining unit further includes a twenty-eighth transistor, a twenty-ninth transistor, a thirtieth transistor, and a thirty-first transistor; a gate of the twenty-first transistor is electrically connected to a second control signal line, one of a source and a drain of the twenty-first transistor is electrically connected to the second control signal line, and another one of the source and the drain of the twenty-first transistor is electrically connected to a third node; a gate of the twenty-second transistor is electrically connected to a first control signal line, one of a source and a drain of the twenty-second transistor is electrically connected to a second power signal line, and another one of the source and the drain of the twenty-second transistor is electrically connected to the third node; a gate of the twenty-third transistor is electrically connected to a stage-transmission signal output terminal of an (i−a)-th stage of gate driving unit, one of a source and a drain of the twenty-third transistor is electrically connected to the second power signal line, and another one of the source and the drain of the twenty-third transistor is electrically connected to the third node; a gate of the twenty-fourth transistor is electrically connected to a stage-transmission signal output terminal of an (i−b)-th stage of gate driving unit, one of a source and a drain of the twenty-fourth transistor is electrically connected to the second power signal line, and another one of the source and the drain of the twenty-fourth transistor is electrically connected to the third node; a gate of the twenty-fifth transistor is electrically connected to the stage-transmission signal output terminal of the i-th stage of gate driving unit, one of a source and a drain of the twenty-fifth transistor is electrically connected to the second power signal line, and another one of the source and the drain of the twenty-fifth transistor is electrically connected to the third node; a gate of the twenty-sixth transistor is electrically connected to a stage-transmission signal output terminal of an (i+c)-th stage of gate driving unit, one of a source and a drain of the twenty-sixth transistor is electrically connected to the second power signal line, and another one of the source and the drain of the twenty-sixth transistor is electrically connected to the third node; a gate of the twenty-seventh transistor is electrically connected to the first node, one of a source and a drain of the twenty-seventh transistor is electrically connected to the second power signal line, and another one of the source and the drain of the twenty-seventh transistor is electrically connected to the third node; a gate of the twenty-eighth transistor is electrically connected to the third node, one of a source and a drain of the twenty-eighth transistor is electrically connected to a third power signal line, and another one of the source and the drain of the twenty-eighth transistor is electrically connected to the first gate driving signal output terminal; a gate of the twenty-ninth transistor is electrically connected to the third node, one of a source and a drain of the twenty-ninth transistor is electrically connected to the second power signal line, and another one of the source and the drain of the twenty-ninth transistor is electrically connected to the stage-transmission signal output terminal of the i-th stage of gate driving unit; a gate of the thirtieth transistor is electrically connected to the third node, one of a source and a drain of the thirtieth transistor is electrically connected to the second power signal line, and another one of the source and the drain of the thirtieth transistor is electrically connected to the first node; and a gate of the thirty-first transistor is electrically connected to the third node, one of a source and a drain of the thirty-first transistor is electrically connected to the third power signal line, and another one of the source and the drain of the thirty-first transistor is electrically connected to the second gate driving signal output terminal; where a, b, and c are positive integers.

In the above display device, channel widths of the twenty-third transistor, the twenty-fourth transistor, the twenty-fifth transistor, the twenty-sixth transistor, and the twenty-seventh transistor are greater than a channel width of the twenty-second transistor, and the channel width of the twenty-second transistor is greater than a channel width of the twenty-first transistor.

In the above display device, the first gate driving signal output terminal is electrically connected to the gate line of the (2i−1)-th row of pixel units, and the second gate driving signal output terminal is electrically connected to the gate line of the 2i-th row of pixel units.

In the above display device, the pull-up unit further includes a first capacitor, a first electrode plate of the first capacitor is electrically connected to the first node, and a second electrode plate of the first capacitor is electrically connected to the first gate driving signal output terminal; and/or the pull-up unit further includes a second capacitor, a first electrode plate of the second capacitor is electrically connected to the first node, and a second electrode plate of the second capacitor is electrically connected to the second gate driving signal output terminal.

In the above display device, transistors in the i-th stage of gate driving unit are oxide semiconductor thin film transistors.

The present disclosure also provides a driving method of a display device, the display device includes a display panel, the display panel includes at least one gate driving circuit and a plurality of pixel units, the plurality of pixel units include 2N rows of pixel units, the gate driving circuit includes N stages of gate driving units, and an i-th stage of gate driving unit is electrically connected to a gate line of a (2i−1)-th row of pixel units and a gate line of a 2i-th row of pixel units; the i-th stage of gate driving unit includes a pull-up unit, the pull-up unit includes a first transistor and a second transistor, a gate of the first transistor and a gate of the second transistor are both electrically connected to a first node, one of a source and a drain of the first transistor is electrically connected to a first clock signal line, another one of the source and the drain of the first transistor is electrically connected to a first gate driving signal output terminal, one of a source and a drain of the second transistor is electrically connected to a second clock signal line, and another one of the source and the drain of the second transistor is electrically connected to a second gate driving signal output terminal; the driving method includes that: when the first node is in a high-potential state, the first transistor is turned on, a first clock signal transmitted by the first clock signal line is transmitted to the first gate driving signal output terminal through the first transistor, the second transistor is turned on, a second clock signal transmitted by the second clock signal line is transmitted to the second gate driving signal output terminal through the second transistor, and an output time of an effective level of the first clock signal is different from an output time of an effective level of the second clock signal; where i and N are positive integers, and i is less than or equal to N.

In the above driving method, the i-th stage of gate driving unit further includes a pull-down maintaining unit, the pull-down maintaining unit includes a first inverter and a second inverter, each of the first inverter and the second inverter includes a plurality of transistors electrically connected to stage-transmission signal output terminals at different stages, a width of an effective pulse of any one of the stage transmission signals output by the stage-transmission signal output terminals at different stages is less than a width of an effective pulse of the signal transmitted by the first node, and a sum of widths of effective pulses of the stage transmission signals output by the stage-transmission signal output terminals at different stages is greater than the width of the effective pulse of the signal transmitted by the first node.

In the above driving method, each of the first inverter and the second inverter includes four transistors electrically connected to a stage-transmission signal output terminal of an (i−a)-th stage of gate driving unit, a stage-transmission signal output terminal of an (i−b)-th stage of gate driving unit, the stage-transmission signal output terminal of the i-th stage of gate driving unit, and a stage-transmission signal output terminal of an (i+c)-th stage of gate driving unit, respectively.

In the above driving method, a width of an effective pulse of a stage-transmission signal output by the stage-transmission signal output terminal of the (i−a)-th stage of gate driving unit, a width of an effective pulse of a stage-transmission signal output by the stage-transmission signal output terminal of the (i−b)-th stage of gate driving unit, a width of an effective pulse of a stage-transmission signal output by the stage-transmission signal output terminal of the i-th stage of gate driving unit, and a width of an effective pulse of a stage-transmission signal output by the stage-transmission signal output terminal of the (i+c)-th stage of gate driving unit are all less than a width of an effective pulse of a signal transmitted by the first node; and
a sum of the width of the effective pulse of the stage-transmission signal output by the stage-transmission signal output terminal of the (i−a)-th stage of gate driving unit, the width of the effective pulse of the stage-transmission signal output by the stage-transmission signal output terminal of the (i−b)-th stage of gate driving unit, the width of the effective pulse of the stage-transmission signal output by the stage-transmission signal output terminal of the i-th stage of gate driving unit, and the width of the effective pulse of the stage-transmission signal output by the stage-transmission signal output terminal of the (i+c)-th stage of gate driving unit is greater than the width of the effective pulse of the signal transmitted by the first node.

In the above driving method, a driving period of one frame image includes a first time period, a second time period, a third time period, a fourth time period, and a fifth time period; and the driving method further includes that:
in the first time period, a stage-transmission signal output terminal of an (i−a)-th stage of gate driving unit outputs a high-level signal, a stage-transmission signal output terminal of an (i−b)-th stage of gate driving unit outputs a low-level signal, the stage-transmission signal output terminal of the i-th stage of gate driving unit outputs a low-level signal, a stage-transmission signal output terminal of an (i+c)-th stage of gate driving unit outputs a low-level signal, and the potential of the first node is a first potential;
in the second time period, the stage-transmission signal output terminal of the (i−a)-th stage of gate driving unit outputs a low-level signal, the stage-transmission signal output terminal of the (i−b)-th stage of gate driving unit outputs a high-level signal, the stage-transmission signal output terminal of the i-th stage of gate driving unit outputs a low-level signal, the stage-transmission signal output terminal of the (i+c)-th stage of gate driving unit outputs a low-level signal, the potential of the first node is a second potential, and the second potential is greater than the first potential;
in the third time period, the stage-transmission signal output terminal of the (i−a)-th stage of gate driving unit outputs a low-level signal, the stage-transmission signal output terminal of the (i−b)-th stage of gate driving unit outputs a low-level signal, the stage-transmission signal output terminal of the i-th stage of gate driving unit outputs a high-level signal, the stage-transmission signal output terminal of the (i+c)-th stage of gate driving unit outputs a low-level signal, the potential of the first node is a third potential, and the third potential is greater than the second potential;
in the fourth time period, the stage-transmission signal output terminal of the (i−a)-th stage of gate driving unit outputs a low-level signal, the stage-transmission signal output terminal of the (i−b)-th stage of gate driving unit outputs a low-level signal, the stage-transmission signal output terminal of the i-th stage of gate driving unit outputs a low-level signal, the stage-transmission signal output terminal of the (i+c)-th stage of gate driving unit outputs a high-level signal, and the potential of the first node is the second potential; and
in the fifth time period, the stage-transmission signal output terminal of the (i−a)-th stage of gate driving unit outputs a low-level signal, the stage-transmission signal output terminal of the (i−b)-th stage of gate driving unit outputs a low-level signal, the stage-transmission signal output terminal of the i-th stage of gate driving unit outputs a low-level signal, the stage-transmission signal output terminal of the (i+c)-th stage of gate driving unit outputs a low-level signal, and the potential of the first node is the first potential, where a, b, and c are positive integers.

In the above driving method, the i-th stage of gate driving unit further includes a reset unit, and the reset unit is electrically connected to the first node, the first gate driving signal output terminal, the second gate driving signal output terminal, and a stage-transmission signal output terminal; and the driving method further includes that: in a reset phase, the reset unit pulls down potentials of the first node, the first gate driving signal output terminal, the second gate driving signal output terminal, and the stage-transmission signal output terminal to low-potential states.

In the display device provided by the embodiments of the present disclosure, the i-th stage of gate driving unit outputs gate driving signals for driving two rows of pixel units, that is, the i-th stage of gate driving unit is electrically connected to the gate line of the (2i−1)-th row of pixel units and the gate line of the 2i-th row of pixel units, and the i-th stage of gate driving unit outputs a first gate driving signal to the (2i−1)-th row of pixel units and outputs a second gate driving signal to the 2i-th row of pixel units. The pull-up unit includes a first transistor and a second transistor, gates of the first transistor and the second transistor are both electrically connected to the first node, one of a source and a drain of the first transistor is electrically connected to a first clock signal line, another one of the source and the drain is electrically connected to a first gate driving signal output terminal, one of a source and a drain of the second transistor is electrically connected to a second clock signal line, and another one of the source and the drain is electrically connected to a second gate driving signal output terminal. When the first node is in a high-potential state, the first transistor and the second transistor are turned on at the same time, the first clock signal transmitted by the first clock signal line is transmitted to the first gate driving signal output terminal through the first transistor, and the second clock signal transmitted by the second clock signal line is transmitted to the second gate driving signal output terminal through the second transistor. Since the output time of the effective level of the first clock signal and the output time of the effective level of the second clock signal are different, the first gate driving signal output terminal and the second gate driving signal output terminal output effective levels at different times, thereby realizing the function of outputting two gate driving signals by one stage of gate driving unit. In this way, the number of rows of the pixel units in the display panel is twice the number of stages of the gate driving units in the gate driving circuit. Compared with the traditional gate driving circuit requiring two stages of gate driving units to output the gate driving signals for driving two rows of pixel units, the technical solutions in the present disclosure only requires one stage of gate driving unit to realize the function of outputting the gate driving signals for driving two rows of pixel units, which reduces the number of transistors in the gate driving units, thereby reducing the occupied area of the gate driving circuit.

In the display device provided by the embodiments of the present disclosure, the pull-down maintaining unit includes at least two inverters, and the inverters are electrically connected to the stage-transmission signal output terminal of the i-th stage of gate driving unit, the first node, the first gate driving signal output terminal, and the second gate driving signal output terminal. The inverter receives a stage transmission signal output by the stage-transmission signal output terminal and a signal at the first node, and the stage transmission signal serves as a dedicated signal in the gate driving unit, which is not affected by the signal in a display area of the display panel, and the signal at the inverter is more stable. The inverter controlled by the stage transmission signal and the signal at the first node has stronger stability, when either of the stage transmission signal and the signal at the first node fails, the inverter still works normally, and the reliability of the gate driving circuit is improved by means of the input of the single stage transmission signal or the single signal at the first node.

The inverter includes a plurality of transistors, gates of these transistors are respectively electrically connected to a stage-transmission signal output terminal of an (i−a)-th stage of gate driving unit, a stage-transmission signal output terminal of an (i−b)-th stage of gate driving unit, a stage-transmission signal output terminal of the i-th stage of gate driving unit, a stage-transmission signal output terminal of an (i+c)-th stage of gate driving unit, and the first node; the stage transmission signal received by the inverter covers the same waveform width range as the signal at the first node, and the inverter can operate normally during an entire time period corresponding to the effective level of the signal at the first node, thereby ensuring the output performance of the gate driving circuit.

The channel width of the transistor, in the inverter, connected to the stage-transmission signal output terminal and the first node is greater than the channel width of the transistor connected to the second control signal line or the first control signal line, and the channel width of the transistor connected to the second control signal line or the first control signal line is greater than the channel width of the transistor connected to the first control signal line or the second control signal line, so that the inverter can output the waveform with high reliability, and the stability of the gate driving circuit is improved.

Compared with that 32 thin film transistors are included in two stages of gate driving units outputting gate driving signals for driving two rows of pixel units in a traditional gate driving circuit, in technical solutions of the present disclosure, one stage of gate driving unit in the present disclosure includes 31 thin film transistors, which saves one thin film transistor and improves reliability. Compared with that 40 thin film transistors or more are included in two stages of gate driving units outputting gate driving signals for driving two rows of pixel units in the traditional gate driving circuit with high reliability, on the premise of meeting the same reliability requirement, the technical solutions in the present disclosure save at least 9 thin film transistors, reduce the occupied area of the gate driving circuit, and meet the requirement of a narrow frame display panel.

Technical solutions in different embodiments of the present disclosure may be combined with each other.

A display device provided in embodiments of the present disclosure may be, for example, an LCD display device, an OLED display device, a Mini-LED display device, or a Micro-LED display device, and the embodiments of the present disclosure are described by taking the LCD display device as an example.

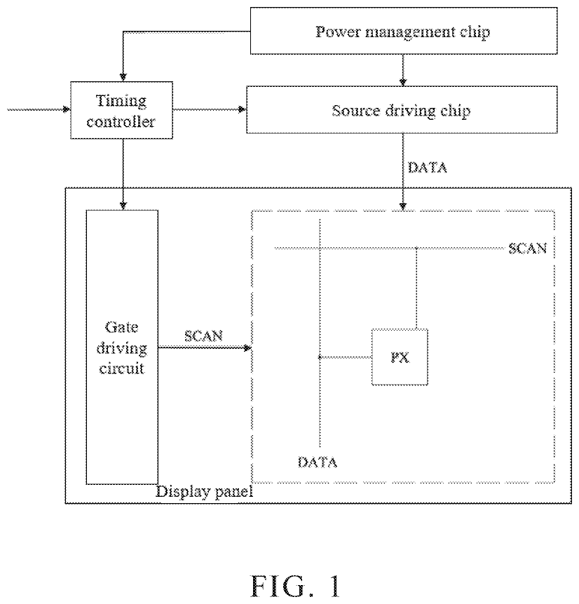

As shown in FIG. 1, embodiments of the present disclosure provide a display device, and the display device includes a display panel, a source driving chip, and a timing controller. The display panel includes at least one gate driving circuit, a plurality of pixel units PX, a plurality of data lines DATA, and a plurality of gate lines SCAN.

In the display device of the present disclosure, the source driving chip is electrically connected to the plurality of data lines DATA, the timing controller is electrically connected to the source driving chip and the gate driving circuit, and the timing controller is configured to provide control signals to the source driving chip and the gate driving circuit. The timing controller receives externally inputted image data and control signals, the timing controller processes the image data and transmits the processed image data to the source driving chip, and the source driving chip generates data voltage signals according to the image data and transmits the data voltage signals to the pixel units PX through the plurality of data lines DATA. The timing controller further provides clock signals, control signals, etc. to the gate driving circuit, and the gate driving circuit generates gate driving signals according to the clock signals and the control signals and transmits the gate driving signals to the pixel units PX through the plurality of gate lines SCAN. The pixel unit PX includes a thin film transistor and a liquid crystal capacitor, a gate of the thin film transistor is electrically connected to the gate line SCAN, a source of the thin film transistor is electrically connected to the data line DATA, and a drain of the thin film transistor is electrically connected to an electrode plate of the liquid crystal capacitor. When the gate driving signal transmitted by the gate line SCAN is at an effective level, the thin film transistor is turned on, the data voltage signal transmitted by the data line DATA is transmitted to the liquid crystal capacitor through the thin film transistor, the liquid crystal capacitor stores the data voltage signal, and the voltage difference between the two electrode plates of the liquid crystal capacitor controls the deflection angle of the liquid crystal molecules, thereby controlling the light transmittance of the pixel unit PX and realizing image display.

The plurality of pixel units PX are arranged in an array, the plurality of pixel units PX include 2N rows of pixel units PX, the gate driving circuit includes N stages of gate driving units, and the N stages of gate driving units are connected in cascade. An i-th stage of gate driving unit is electrically connected to a gate line SCAN of a (2i−1)-th row of pixel units PX and a gate line SCAN of a 2i-th row of pixel units PX, and the i-th stage of gate driving unit outputs a first gate driving signal to the (2i−1)-th row of pixel units PX and outputs a second gate driving signal to the 2i-th row of pixel units PX, where i and N are positive integers, and i is less than or equal to N. The number of the rows of the pixel units PX in the display panel is twice the number of the stages of the gate driving units in the gate driving circuit.

A first gate driving signal output terminal G(2i−1) is electrically connected to the gate line SCAN of the (2i−1)-th row of pixel units PX, and a second gate driving signal output terminal G(2i) is electrically connected to the gate line SCAN of the 2i-th row of pixel units PX. In this way, one stage of gate driving unit outputs two gate driving signals to respectively drive the two rows of pixel units PX. Compared with the traditional gate driving circuit in which one stage of gate driving unit outputs one gate driving signal to drive one row of pixel units PX, the technical solutions in the present disclosure reduce the number of the stages of gate driving units, thereby reducing the occupied area of the gate driving circuit.

The thin film transistors in the gate driving units are oxide semiconductor thin film transistors, that is, the materials of active layers of the thin film transistors in the gate driving units are oxide semiconductor materials, and the oxide semiconductor material includes at least one of indium gallium zinc oxide, indium zinc oxide, indium tin oxide, indium gallium zinc tin oxide, indium gallium tin oxide, and indium gallium oxide.

The active layers of the first transistor T21, the second transistor T23, and the transistors in the pull-down maintaining unit 104 are made of oxide semiconductor materials. The high mobility characteristic of the oxide semiconductor material enables the first transistor T21 and the second transistor T23 to have a stronger current driving capability when being turned on, so that the voltage amplitudes of the gate driving signals output by the first gate driving signal output terminal G(2i−1) and the second gate driving signal output terminal G(2i) are higher, thereby improving the driving capability of the gate driving signals. The low leakage current characteristic of the oxide semiconductor material enables the leakage current of the transistors in the pull-down maintaining unit 104 to be small when turned off, so that low-potential states of the first gate driving signal output terminal G(2i−1), the second gate driving signal output terminal G(2i), the stage-transmission signal output terminal ST(i) of the i-th stage of gate driving unit, and the first node Q(i) are more stable, and the stability of the gate driving circuit is improved.

The i-th stage of gate driving unit includes a pull-up control unit 101, a reset unit 103, a pull-down maintaining unit 104, a pull-up unit 102, and a pull-down unit 105.

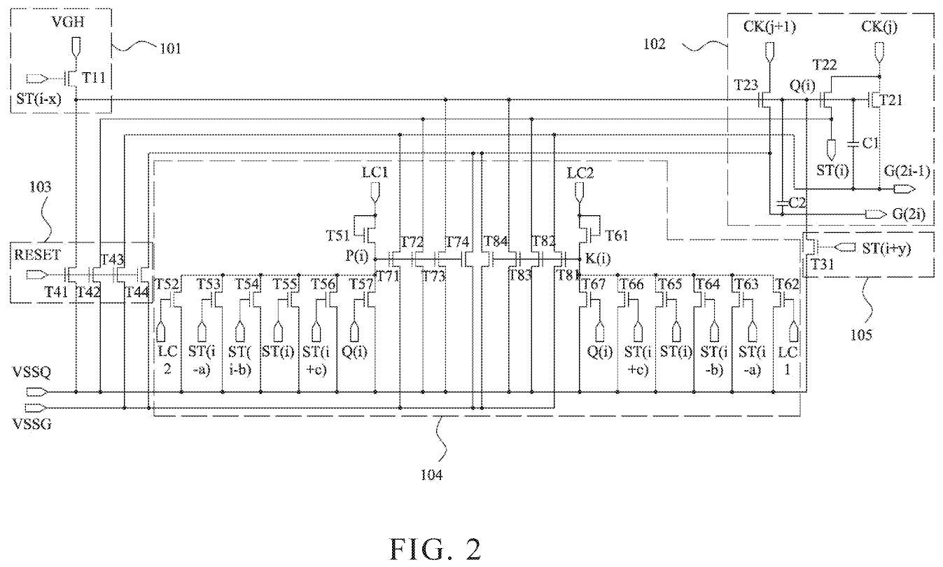

As shown in FIG. 2, the pull-up control unit 101 is configured to control the potential of the first node Q(i). The pull-up control unit 101 includes a third transistor T11, a gate of the third transistor T11 is electrically connected to a stage-transmission signal output terminal ST(i−x) of an (i−x)-th stage of gate driving unit, one of a source and a drain of the third transistor T11 is electrically connected to one of a first power signal line VGH, a gate driving signal output terminal G(i−x) at the (i−x)-th stage, and the stage-transmission signal output terminal ST(i−x) of the (i−x)-th stage of gate driving unit, and another one of the source and the drain of the third transistor T11 is electrically connected to the first node Q(i), where x is a positive integer. The first node Q(i) is electrically connected to the gate of the first transistor T21.

In an embodiment, the gate of the third transistor T11 is electrically connected to the stage-transmission signal output terminal ST(i−x) of the (i−x)-th stage of gate driving unit, one of the source and the drain of the third transistor T11 is electrically connected to the first power signal line VGH, and another one of the source and the drain of the third transistor T11 is electrically connected to the first node Q(i). When the stage-transmission signal output terminal ST(i−x) of the (i−x)-th stage of gate driving unit outputs a high-level signal, the third transistor T11 is turned on, and the high-level signal transmitted by the first power signal line VGH is transmitted to the first node Q(i) through the third transistor T11, so that the potential of the first node Q(i) is pulled up to a high-level state.

In another embodiment, the gate of the third transistor T11 is electrically connected to the stage-transmission signal output terminal ST(i−x) of the (i−x)-th stage of gate driving unit, one of the source and the drain of the third transistor T11 is electrically connected to the stage-transmission signal output terminal ST(i−x) of the (i−x)-th stage of gate driving unit, and another one of the source and the drain of the third transistor T11 is electrically connected to the first node Q(i). In this way, the gate and one of the source and the drain of the third transistor T11 are electrically connected to the stage-transmission signal output terminal ST(i−x) of the (i−x)-th stage of gate driving unit; and when the stage-transmission signal output terminal ST(i−x) of the (i−x)-th stage of gate driving unit outputs a high-level signal, the third transistor T11 is turned on, and the high-level signal output by the stage-transmission signal output terminal ST(i−x) of the (i−x)-th stage of gate driving unit is transmitted to the first node Q(i) through the third transistor T11, so that the potential of the first node Q(i) is pulled up to a high-level state.

In yet another embodiment, the gate of the third transistor T11 is electrically connected to the gate driving signal output terminal G(i−x) at the (i−x)-th stage, one of the source and the drain of the third transistor T11 is electrically connected to the first power signal line VGH, and another one of the source and the drain of the third transistor T11 is electrically connected to the first node Q(i). When the gate driving signal output terminal G(i−x) at the (i−x)-th stage outputs a high-level signal, the third transistor T11 is turned on, and the high-level signal transmitted by the first power signal line VGH is transmitted to the first node Q(i) through the third transistor T11, so that the potential of the first node Q(i) is pulled up to a high-level state.

x is greater than or equal to 1 and is less than or equal to the number of clock signal lines of the gate driving circuit. Specifically, x is half of the number of clock signal lines of the gate driving circuit. The gate driving circuit includes a plurality of clock signal lines, the number of the clock signal lines ranges from 12 to 16, and x ranges from 6 to 8. For example, the number of clock signal lines is 12, and x is 6. In this way, the gate of the third transistor T11 is electrically connected to the stage-transmission signal output terminal ST(i−6) of the (i−6)-th stage of gate driving unit, and the high-level signal output by the stage-transmission signal output terminal ST(i−6) of the (i−6)-th stage of gate driving unit is transmitted to the first node Q(i) through the third transistor T11, so that the potential of the first node Q(i) is pulled up to a high-level state, thereby controlling the conduction states of the first transistor T21 and the second transistor T23.

The i-th stage of gate driving unit further includes a reset unit 103, and the reset unit 103 is configured to reset a potential of a key node in the gate driving unit at the beginning of each frame. The reset unit 103 includes a fifth transistor T41, a sixth transistor T42, a seventh transistor T43, and an eighth transistor T44. A gate of the fifth transistor T41 is electrically connected to a reset control signal line RESET, one of a source and a drain of the fifth transistor T41 is electrically connected to a second power signal line VSSQ, and another one of the source and the drain of the fifth transistor T41 is electrically connected to the first node Q(i). A gate of the sixth transistor T42 is electrically connected to the reset control signal line RESET, one of a source and a drain of the sixth transistor T42 is electrically connected to the second power signal line VSSQ, and another one of the source and the drain of the sixth transistor T42 is electrically connected to the stage-transmission signal output terminal ST(i) of the i-th stage of gate driving unit. A gate of the seventh transistor T43 is electrically connected to the reset control signal line RESET, one of a source and a drain of the seventh transistor T43 is electrically connected to a third power signal line VSSG, and another one of the source and the drain of the seventh transistor T43 is electrically connected to the first gate driving signal output terminal G(2i−1). A gate of the eighth transistor T44 is electrically connected to the reset control signal line RESET, one of a source and a drain of the eighth transistor T44 is electrically connected to the third power signal line VSSG, and another one of the source and the drain of the eighth transistor T44 is electrically connected to the second gate driving signal output terminal G(2i).

The reset unit 103 is electrically connected to the first node Q(i), the first gate driving signal output terminal G(2i−1), the second gate driving signal output terminal G(2i), and the stage-transmission signal output terminal ST(i). The reset control signal line RESET transmits a reset control signal, and the reset control signal outputs a high-level signal in a reset phase at the beginning of each frame, that is, in the reset phase, the reset unit 103 pulls down potentials of the first node Q(i), the first gate driving signal output terminal G(2i−1), the second gate driving signal output terminal G(2i), and the stage-transmission signal output terminal ST(i) to low-potential states. When the reset control signal line RESET outputs a high-level signal, the fifth transistor T41, the sixth transistor T42, the seventh transistor T43, and the eighth transistor T44 are simultaneously turned on; the low-level signal transmitted by the second power signal line VSSQ is transmitted to the first node Q(i) through the fifth transistor T41, so that the potential of the first node Q(i) drops to a low-level state; the low-level signal transmitted by the second power signal line VSSQ is transmitted to the stage-transmission signal output terminal ST(i) of the i-th stage of gate driving unit through the sixth transistor T42, so that the potential of the stage-transmission signal output terminal ST(i) of the i-th stage of gate driving unit drops to a low-level state; the low-level signal transmitted by the third power signal line VSSG is transmitted to the first gate driving signal output terminal G(2i−1) through the seventh transistor T43, so that the potential of the first gate driving signal output terminal G(2i−1) drops to a low-level state; and the low-level signal transmitted by the third power signal line VSSG is transmitted to the second gate driving signal output terminal G(2i) through the eighth transistor T44, so that the potential of the second gate driving signal output terminal G(2i) drops to a low-level state. In this way, the reset unit 103 resets the potentials of the first node Q(i), the stage-transmission signal output terminal ST(i) of the i-th stage of gate driving unit, the first gate driving signal output terminal G(2i−1), and the second gate driving signal output terminal G(2i) at the beginning of each frame to ensure that the gate driving unit is in an initial state at the beginning of each frame.

The pull-up unit 102 is configured to generate and output the gate driving signal and the stage transmission signal. The pull-up unit 102 includes the first transistor T21, the second transistor T23, and a fourth transistor T22. A gate of the first transistor T21 is electrically connected to the first node Q(i), one of a source and a drain of the first transistor T21 is electrically connected to a first clock signal line CK(j), and another one of the source and the drain of the first transistor T21 is electrically connected to the first gate driving signal output terminal G(2i−1). A gate of the second transistor T23 is electrically connected to the first node Q(i), one of a source and a drain of the second transistor T23 is electrically connected to a second clock signal line CK(j+1), and another one of the source and the drain of the second transistor T23 is electrically connected to the second gate driving signal output terminal G(2i). A gate of the fourth transistor T22 is electrically connected to the first node Q(i), one of a source and a drain of the fourth transistor T22 is electrically connected to the first clock signal line CK(j), and another one of the source and the drain of the fourth transistor T22 is electrically connected to the stage-transmission signal output terminal ST(i) of the i-th stage of gate driving unit. The fourth transistor T22 is configured to transmit a first clock signal to the stage-transmission signal output terminal ST(i) of the i-th stage of gate driving unit to generate and output the stage transmission signal.

The first clock signal line CK(j) transmits the first clock signal, the second clock signal line CK(j+1) transmits a second clock signal, and the output time of the effective level of the first clock signal is different from the output time of the effective level of the second clock signal. The output time of the effective level of the first clock signal is earlier than the output time of the effective level of the second clock signal. In this way, the time when the first gate driving signal output terminal G(2i−1) outputs the gate driving signal is earlier than the time when the second gate driving signal output terminal G(2i) outputs the gate driving signal, so that the pixel units PX in the (2i−1)-th row are driven before the pixel units PX in the 2i-th row.

The duty cycles of the clock signals transmitted by the first clock signal line CK(j) and the second clock signal line CK(j+1) range from 40% to 44%. The duty cycle of the clock signal refers to a ratio of a duration of the high level of the clock signal in one cycle period to the entire cycle period.

When the first node Q(i) is in a high-potential state, the first transistor T21, the second transistor T23, and the fourth transistor T22 are simultaneously turned on, the first clock signal transmitted by the first clock signal line CK(j) is transmitted to the first gate driving signal output terminal G(2i−1) through the first transistor T21, the second clock signal transmitted by the second clock signal line CK(j+1) is transmitted to the second gate driving signal output terminal G(2i) through the second transistor T23, and the first clock signal transmitted by the first clock signal line CK(j) is transmitted to the stage-transmission signal output terminal ST(i) of the i-th stage of gate driving unit through the fourth transistor T22. Since the output time of the effective level of the first clock signal is different from the output time of the effective level of the second clock signal, the first gate driving signal output terminal G(2i−1) and the second gate driving signal output terminal G(2i) output the effective levels at different times, thereby realizing the function of outputting two gate driving signals by one stage of gate driving unit.

The pull-up unit 102 further includes a first capacitor C1, a first electrode plate of the first capacitor C1 is electrically connected to the first node Q(i), and a second electrode plate of the first capacitor C1 is electrically connected to the first gate driving signal output terminal G(2i−1). When the potential of the first gate driving signal output terminal G(2i−1) is pulled up, the potential of the second electrode plate of the first capacitor C1 rises, and due to the coupling effect of the capacitor, the potential of the first electrode plate of the first capacitor C1 also rises, so that the potential of the first node Q(i) further rises, the gate potential of the first transistor T21 is increased, the conduction capability of the first transistor T21 is enhanced, the voltage amplitude of the gate driving signal output by the first gate driving signal output terminal G(2i−1) is higher, and the driving capability of the gate driving signal is improved.

In an embodiment, the pull-up unit 102 further includes a second capacitor C2, a first electrode plate of the second capacitor C2 is electrically connected to the first node Q(i), and a second electrode plate of the second capacitor C2 is electrically connected to the second gate driving signal output terminal G(2i). When the potential of the second gate driving signal output terminal G(2i) is pulled up, the potential of the second electrode plate of the second capacitor C2 rises, and due to the coupling effect of the capacitor, the potential of the first electrode plate of the second capacitor C2 also rises, so that the potential of the first node Q(i) further rises, the gate potential of the second transistor T23 is increased, the conduction capability of the second transistor T23 is enhanced, the voltage amplitude of the gate driving signal output by the second gate driving signal output terminal G(2i) is higher, and the driving capability of the gate driving signal is improved.

The i-th stage of gate driving unit further includes a pull-down unit 105, and the pull-down unit 105 is configured to pull down the potential of the first node Q(i). The pull-down unit 105 includes a ninth transistor T31, a gate of the ninth transistor T31 is electrically connected to a stage-transmission signal output terminal ST(i+y) of an (i+y)-th stage of gate driving unit, one of a source and a drain of the ninth transistor T31 is electrically connected to the second power signal line VSSQ, and another one of the source and the drain of the ninth transistor T31 is electrically connected to the first node Q(i), where y is a positive integer.

In an embodiment, y is 8, and the gate of the ninth transistor T31 is electrically connected to the stage-transmission signal output terminal ST(i+8) of the (i+8)-th stage of gate driving unit. When the stage-transmission signal output terminal ST(i+8) of the (i+8)-th stage of gate driving unit outputs a high-level signal, the ninth transistor T31 is turned on, and the low-level signal transmitted by the second power signal line VSSQ is transmitted to the first node Q(i) through the ninth transistor T31, so that the potential of the first node Q(i) drops to a low-potential state, thereby turning off the first transistor T21, the second transistor T23, and the fourth transistor T22; and the first gate driving signal output terminal G(2i−1), the second gate driving signal output terminal G(2i), and the stage-transmission signal output terminal ST(i) of the i-th stage of gate driving unit stop outputting the gate driving signals.

The pull-down maintaining unit 104 is electrically connected to the first gate driving signal output terminal G(2i−1), the second gate driving signal output terminal G(2i), the stage-transmission signal output terminal ST(i), and the first node Q(i). The pull-down maintaining unit 104 is configured to maintain low-potential states of the first gate driving signal output terminal G(2i−1), the second gate driving signal output terminal G(2i), the stage-transmission signal output terminal ST(i) of the i-th stage of gate driving unit, and the first node Q(i).

The pull-down maintaining unit 104 includes at least two inverters, the at least two inverters include a first inverter and a second inverter, and each of the first inverter and the second inverter includes a plurality of transistors electrically connected to stage-transmission signal output terminals at different stages. A width of an effective pulse of any one of stage transmission signals output by the stage-transmission signal output terminals at different stages is less than a width of an effective pulse of a signal transmitted by the first node Q(i), and a sum of widths of effective pulses of the stage transmission signals output by the stage-transmission signal output terminals at different stages is greater than the width of the effective pulse of the signal transmitted by the first node Q(i).

The first inverter includes a tenth transistor T51, an eleventh transistor T52, a twelfth transistor T53, a thirteenth transistor T54, a fourteenth transistor T55, a fifteenth transistor T56, and a sixteenth transistor T57. The pull-down maintaining unit 104 further includes a seventeenth transistor T71, an eighteenth transistor T72, a nineteenth transistor T73, and a twentieth transistor T74.

A gate of the tenth transistor T51 is electrically connected to a first control signal line LC1, one of a source and a drain of the tenth transistor T51 is electrically connected to a first control signal line LC1, and another one of the source and the drain of the tenth transistor T51 is electrically connected to a second node P(i). A gate of the eleventh transistor T52 is electrically connected to a second control signal line LC2, one of a source and a drain of the eleventh transistor T52 is electrically connected to a second power signal line VSSQ, and another one of the source and the drain of the eleventh transistor T52 is electrically connected to the second node P(i). A gate of the twelfth transistor T53 is electrically connected to a stage-transmission signal output terminal ST(i−a) of an (i−a)-th stage of gate driving unit, one of a source and a drain of the twelfth transistor T53 is electrically connected to a second power signal line VSSQ, and another one of the source and the drain of the twelfth transistor T53 is electrically connected to the second node P(i). A gate of the thirteenth transistor T54 is electrically connected to a stage-transmission signal output terminal ST(i−b) of an (i−b)th stage of gate driving unit, one of a source and a drain of the thirteenth transistor T54 is electrically connected to the second power signal line VSSQ, and another one of the source and the drain of the thirteenth transistor T54 is electrically connected to the second node P(i). A gate of the fourteenth transistor T55 is electrically connected to the stage-transmission signal output terminal ST(i) of the i-th stage of gate driving unit, one of a source and a drain of the fourteenth transistor T55 is electrically connected to the second power signal line VSSQ, and another one of the source and the drain of the fourteenth transistor T55 is electrically connected to the second node P(i). A gate of the fifteenth transistor T56 is electrically connected to a stage-transmission signal output terminal ST(i+c) of an (i+c)-th stage of gate driving unit, one of a source and a drain of the fifteenth transistor T56 is electrically connected to the second power signal line VSSQ, and another one of the source and the drain of the fifteenth transistor T56 is electrically connected to the second node P(i). A gate of the sixteenth transistor T57 is electrically connected to the first node Q(i), one of a source and a drain of the sixteenth transistor T57 is electrically connected to the second power signal line VSSQ, and another one of the source and the drain of the sixteenth transistor T57 is electrically connected to the second node P(i). A gate of the seventeenth transistor T71 is electrically connected to the second node P(i), one of a source and a drain of the seventeenth transistor T71 is electrically connected to a third power signal line VSSG, and another one of the source and the drain of the seventeenth transistor T71 is electrically connected to the first gate driving signal output terminal G(2i−1). A gate of the eighteenth transistor T72 is electrically connected to the second node P(i), one of a source and a drain of the eighteenth transistor T72 is electrically connected to the second power signal line VSSQ, and another one of the source and the drain of the eighteenth transistor T72 is electrically connected to the stage-transmission signal output terminal ST(i) of the i-th stage of gate driving unit. A gate of the nineteenth transistor T73 is electrically connected to the second node P(i), one of a source and a drain of the nineteenth transistor T73 is electrically connected to the second power signal line VSSQ, and another one of the source and the drain of the nineteenth transistor T73 is electrically connected to the first node Q(i). A gate of the twentieth transistor T74 is electrically connected to the second node P(i), one of a source and a drain of the twentieth transistor T74 is electrically connected to the third power signal line VSSG, and another one of the source and the drain of the twentieth transistor T74 is electrically connected to the second gate driving signal output terminal G(2i), where a, b, and c are positive integers.

In an embodiment, a is 8, b is 4, and c is 4. The gate of the twelfth transistor T53 is electrically connected to the stage-transmission signal output terminal ST(i−8) of the (i−8)-th stage of gate driving unit, the gate of the thirteenth transistor T54 is electrically connected to the stage-transmission signal output terminal ST(i−4) of the (i−4)-th stage of gate driving unit, and the gate of the fifteenth transistor T56 is electrically connected to the stage-transmission signal output terminal ST(i+4) of the (i+4)-th stage of gate driving unit.

The first control signal line LC1 transmits the first control signal, the second control signal line LC2 transmits the second control signal, and the first control signal transmitted by the first control signal line LC1 and the second control signal transmitted by the second control signal line LC2 are inverted. The first control signal and the second control signal alternate between high and low levels at the second-level granularity. The level states of the first control signal and the second control signal are inverted, when the first control signal is at a high level, the second control signal is at a low level, and when the first control signal is at a low level, the second control signal is at a high level.

When the first control signal line LC1 outputs a high-level signal, the tenth transistor T51 is turned on, and the high-level signal transmitted by the first control signal line LC1 is transmitted to the second node P(i) through the tenth transistor T51, so that the potential of the second node P(i) is pulled up to a high-level state. When the second node P(i) is in the high-potential state, the seventeenth transistor T71, the eighteenth transistor T72, the nineteenth transistor T73, and the twentieth transistor T74 are simultaneously turned on; the low-level signal transmitted by the third power signal line VSSG is transmitted to the first gate driving signal output terminal G(2i−1) through the seventeenth transistor T71, so that the potential of the first gate driving signal output terminal G(2i−1) is maintained in the low-potential state; the low-level signal transmitted by the second power signal line VSSQ is transmitted to the stage-transmission signal output terminal ST(i) of the i-th stage of gate driving unit through the eighteenth transistor T72, so that the potential of the stage-transmission signal output terminal ST(i) of the i-th stage of gate driving unit is maintained in the low-potential state; the low-level signal transmitted by the second power signal line VSSQ is transmitted to the first node Q(i) through the nineteenth transistor T73, so that the potential of the first node Q(i) is maintained in the low-potential state; and the low-level signal transmitted by the third power signal line VSSG is transmitted to the second gate driving signal output terminal G(2i) through the twentieth transistor T74, so that the potential of the second gate driving signal output terminal G(2i) is maintained in the low-potential state.

When the second control signal line LC2 outputs the high-level signal, the eleventh transistor T52 is turned on, and the low-level signal transmitted by the second power signal line VSSQ is transmitted to the second node P(i) through the eleventh transistor T52, so that the potential of the second node P(i) drops to a low-level state. When the second node P(i) is in the low-potential state, the seventeenth transistor T71, the eighteenth transistor T72, the nineteenth transistor T73, and the twentieth transistor T74 are turned off simultaneously, and the potentials of the first gate driving signal output terminal G(2i−1), the stage-transmission signal output terminal ST(i) of the i-th stage of gate driving unit, the first node Q(i), and the second gate driving signal output terminal G(2i) are not affected by the first inverter.

When the stage-transmission signal output terminal ST(i−8) of the (i−8)-th stage of gate driving unit outputs the high-level signal, the twelfth transistor T53 is turned on, and the low-level signal transmitted by the second power signal line VSSQ is transmitted to the second node P(i) through the twelfth transistor T53, so that the potential of the second node P(i) drops to a low-potential state. When the stage-transmission signal output terminal ST(i−4) of the (i−4)-th stage of gate driving unit outputs the high-level signal, the thirteenth transistor T54 is turned on, and the low-level signal transmitted by the second power signal line VSSQ is transmitted to the second node P(i) through the thirteenth transistor T54, so that the potential of the second node P(i) drops to a low-level state. When the stage-transmission signal output terminal ST(i) of the i-th stage of gate driving unit outputs the high-level signal, the fourteenth transistor T55 is turned on, and the low-level signal transmitted by the second power signal line VSSQ is transmitted to the second node P(i) through the fourteenth transistor T55, so that the potential of the second node P(i) drops to a low-level state. When the stage-transmission signal output terminal ST(i+4) of the (i+4)-th stage of gate driving unit outputs the high-level signal, the fifteenth transistor T56 is turned on, and the low-level signal transmitted by the second power signal line VSSQ is transmitted to the second node P(i) through the fifteenth transistor T56, so that the potential of the second node P(i) drops to a low-level state. When the first node Q(i) is in the high-potential state, the sixteenth transistor T57 is turned on, and the low-level signal transmitted by the second power signal line VSSQ is transmitted to the second node P(i) through the sixteenth transistor T57, so that the potential of the second node P(i) drops to a low-potential state.

Gates of the twelfth transistor T53, the thirteenth transistor T54, the fourteenth transistor T55, the fifteenth transistor T56, and the sixteenth transistor T57 are electrically connected to the stage-transmission signal output terminal ST(i−8) of the (i−8)-th stage of gate driving unit, the stage-transmission signal output terminal ST(i−4) of the (i−4)-th stage of gate driving unit, the stage-transmission signal output terminal ST(i) of the i-th stage of gate driving unit, the stage-transmission signal output terminal ST(i+4) of the (i+4)-th stage of gate driving unit, and the first node Q(i), respectively; the stage transmission signal received by the first inverter covers the same waveform width range as the signal at the first node Q(i), and the first inverter operates normally during the entire effective level of the signal at the first node Q(i), thereby ensuring the output performance of the gate driving circuit.

As the dedicated signal in the gate driving unit, the stage transmission signal is not affected by the signals in the display area of the display panel, and the control signal received by the first inverter is more stable. The first inverter, which is controlled by both the stage transmission signal and the signal at the first node Q(i), has stronger stability; when either of the stage transmission signal and the signal at the first node Q(i) fails, the first inverter still works normally, and the reliability of the gate driving circuit is improved by means of the input of the single stage transmission signal or the single signal at the first node Q(i).

Channel widths of the twelfth transistor T53, the thirteenth transistor T54, the fourteenth transistor T55, the fifteenth transistor T56, and the sixteenth transistor T57 are greater than a channel width of the eleventh transistor T52, and the channel width of the eleventh transistor T52 is greater than a channel width of the tenth transistor T51. In this way, the first inverter can output a waveform with high reliability, thereby improving the stability of the gate driving circuit. The channel widths of the twelfth transistor T53, the thirteenth transistor T54, the fourteenth transistor T55, the fifteenth transistor T56, and the sixteenth transistor T57 are relatively large, so that these transistors have a stronger current driving capability when being turned on, so that the potential of the second node P(i) drops faster, and the response speed of the first inverter is faster. The channel width of the eleventh transistor T52 is moderate, so that the eleventh transistor T52 has an appropriate current driving capability when being turned on, which not only ensures the dropping speed of the potential of the second node P(i), but also avoids the increase in area caused by the excessive channel width of the eleventh transistor T52. The channel width of the tenth transistor T51 is relatively small, so that the tenth transistor T51 has a weak current driving capability when being turned on, which ensures the potential of the second node P(i) to rise slowly, thereby avoiding the malfunction of the first inverter caused by the potential of the second node P(i) rising too fast.

The second inverter includes a twenty-first transistor T61, a twenty-second transistor T62, a twenty-third transistor T63, a twenty-fourth transistor T64, a twenty-fifth transistor T65, a twenty-sixth transistor T66, and a twenty-seventh transistor T67. The pull-down maintaining unit 104 further includes a twenty-eighth transistor T81, a twenty-ninth transistor T82, a thirtieth transistor T83, and a thirty-first transistor T84.

A gate of the twenty-first transistor T61 is electrically connected to a second control signal line LC2, one of a source and a drain of the twenty-first transistor T61 is electrically connected to the second control signal line LC2, and another one of the source and the drain of the twenty-first transistor T61 is electrically connected to a third node K(i). A gate of the twenty-second transistor T62 is electrically connected to the first control signal line LC1, one of a source and a drain of the twenty-second transistor T62 is electrically connected to the second power signal line VSSQ, and another one of the source and the drain of the twenty-second transistor T62 is electrically connected to the third node K(i). A gate of the twenty-third transistor T63 is electrically connected to the stage-transmission signal output terminal ST(i−a) of the (i−a)-th stage of gate driving unit, one of a source and a drain of the twenty-third transistor T63 is electrically connected to the second power signal line VSSQ, and another one of the source and the drain of the twenty-third transistor T63 is electrically connected to the third node K(i). A gate of the twenty-fourth transistor T64 is electrically connected to the stage-transmission signal output terminal ST(i−b) of the (i−b)-th stage of gate driving unit, one of a source and a drain of the twenty-fourth transistor T64 is electrically connected to the second power signal line VSSQ, and another one of the source and the drain of the twenty-fourth transistor T64 is electrically connected to the third node K(i). A gate of the twenty-fifth transistor T65 is electrically connected to the stage-transmission signal output terminal ST(i) of the i-th stage of gate driving unit, one of a source and a drain of the twenty-fifth transistor T65 is electrically connected to the second power signal line VSSQ, and another one of the source and the drain of the twenty-fifth transistor T65 is electrically connected to the third node K(i). A gate of the twenty-sixth transistor T66 is electrically connected to the stage-transmission signal output terminal ST(i+c) of the (i+c)-th stage of gate driving unit, one of a source and a drain of the twenty-sixth transistor T66 is electrically connected to the second power signal line VSSQ, and another one of the source and the drain of the twenty-sixth transistor T66 is electrically connected to the third node K(i). A gate of the twenty-seventh transistor T67 is electrically connected to the first node Q(i), one of a source and a drain of the twenty-seventh transistor T67 is electrically connected to the second power signal line VSSQ, and another one of the source and the drain of the twenty-seventh transistor T67 is electrically connected to the third node K(i). A gate of the twenty-eighth transistor T81 is electrically connected to the third node K(i), one of a source and a drain of the twenty-eighth transistor T81 is electrically connected to a third power signal line VSSG, and another one of the source and the drain of the twenty-eighth transistor T81 is electrically connected to the first gate driving signal output terminal G(2i−1). A gate of the twenty-ninth transistor T82 is electrically connected to the third node K(i), one of a source and a drain of the twenty-ninth transistor T82 is electrically connected to the second power signal line VSSQ, and another one of the source and the drain of the twenty-ninth transistor T82 is electrically connected to the stage-transmission signal output terminal ST(i) of the i-th stage of gate driving unit. A gate of the thirtieth transistor T83 is electrically connected to the third node K(i), one of a source and a drain of the thirtieth transistor T83 is electrically connected to the second power signal line VSSQ, and another one of the source and the drain of the thirtieth transistor T83 is electrically connected to the first node Q(i). A gate of the thirty-first transistor T84 is electrically connected to the third node K(i), one of a source and a drain of the thirty-first transistor T84 is electrically connected to the third power signal line VSSG, and another one of the source and the drain of the thirty-first transistor T84 is electrically connected to the second gate driving signal output terminal G(2i), where a, b, and c are positive integers.

In an embodiment, a is 8, b is 4, and c is 4. The gate of the twenty-third transistor T63 is electrically connected to the stage-transmission signal output terminal ST(i−8) of the (i−8)-th stage of gate driving unit, the gate of the twenty-fourth transistor T64 is electrically connected to the stage-transmission signal output terminal ST(i−4) of the (i−4)-th stage of gate driving unit, and the gate of the twenty-sixth transistor T66 is electrically connected to the stage-transmission signal output terminal ST(i+4) of the (i+4)-th stage of gate driving unit.

When the second control signal line LC2 outputs a high-level signal, the twenty-first transistor T61 is turned on, and the high-level signal transmitted by the second control signal line LC2 is transmitted to the third node K(i) through the twenty-first transistor T61, so that the potential of the third node K(i) is pulled up to a high-level state. When the third node K(i) is in the high-potential state, the twenty-eighth transistor T81, the twenty-ninth transistor T82, the thirtieth transistor T83, and the thirty-first transistor T84 are simultaneously turned on; the low-level signal transmitted by the third power signal line VSSG is transmitted to the first gate driving signal output terminal G(2i−1) through the twenty-eighth transistor T81, so that the potential of the first gate driving signal output terminal G(2i−1) is maintained in the low-potential state; the low-level signal transmitted by the second power signal line VSSQ is transmitted to the stage-transmission signal output terminal ST(i) of the i-th stage of gate driving unit through the twenty-ninth transistor T82, so that the potential of the stage-transmission signal output terminal ST(i) of the i-th stage of gate driving unit is maintained in the low-potential state; the low-level signal transmitted by the second power signal line VSSQ is transmitted to the first node Q(i) through the thirtieth transistor T83, so that the potential of the first node Q(i) is maintained in the low-potential state; and the low-level signal transmitted by the third power signal line VSSG is transmitted to the second gate driving signal output terminal G(2i) through the thirty-first transistor T84, so that the potential of the second gate driving signal output terminal G(2i) is maintained in the low-potential state.

When the first control signal line LC1 outputs a high-level signal, the twenty-second transistor T62 is turned on, and the low-level signal transmitted by the second power signal line VSSQ is transmitted to the third node K(i) through the twenty-second transistor T62, so that the potential of the third node K(i) drops to a low-level state. When the third node K(i) is in the low-potential state, the twenty-eighth transistor T81, the twenty-ninth transistor T82, the thirtieth transistor T83, and the thirty-first transistor T84 are turned off simultaneously, and the potentials of the first gate driving signal output terminal G(2i−1), the stage-transmission signal output terminal ST(i) of the i-th stage of gate driving unit, the first node Q(i), and the second gate driving signal output terminal G(2i) are not affected by the second inverter.

When the stage-transmission signal output terminal ST(i−8) of the (i−8)-th stage of gate driving unit outputs the high-level signal, the twenty-third transistor T63 is turned on, and the low-level signal transmitted by the second power signal line VSSQ is transmitted to the third node K(i) through the twenty-third transistor T63, so that the potential of the third node K(i) drops to a low-level state. When the stage-transmission signal output terminal ST(i−4) of the (i−4)-th stage of gate driving unit outputs the high-level signal, the twenty-fourth transistor T64 is turned on, and the low-level signal transmitted by the second power signal line VSSQ is transmitted to the third node K(i) through the twenty-fourth transistor T64, so that the potential of the third node K(i) drops to a low-level state. When the stage-transmission signal output terminal ST(i) of the i-th stage of gate driving unit outputs the high-level signal, the twenty-fifth transistor T65 is turned on, and the low-level signal transmitted by the second power signal line VSSQ is transmitted to the third node K(i) through the twenty-fifth transistor T65, so that the potential of the third node K(i) drops to a low-level state. When the stage-transmission signal output terminal ST(i+4) of the (i+4)-th stage of gate driving unit outputs the high-level signal, the twenty-sixth transistor T66 is turned on, and the low-level signal transmitted by the second power signal line VSSQ is transmitted to the third node K(i) through the twenty-sixth transistor T66, so that the potential of the third node K(i) drops to a low-level state. When the first node Q(i) is in the high-potential state, the twenty-seventh transistor T67 is turned on, and the low-level signal transmitted by the second power signal line VSSQ is transmitted to the third node K(i) through the twenty-seventh transistor T67, so that the potential of the third node K(i) drops to a low-potential state.

Gates of the twenty-third transistor T63, the twenty-fourth transistor T64, the twenty-fifth transistor T65, the twenty-sixth transistor T66, and the twenty-seventh transistor T67 are electrically connected to the stage-transmission signal output terminal ST(i−8) of the (i−8)-th stage of gate driving unit, the stage-transmission signal output terminal ST(i−4) of the (i−4)-th stage of gate driving unit, the stage-transmission signal output terminal ST(i) of the i-th stage of gate driving unit, the stage-transmission signal output terminal ST(i+4) of the (i+4)-th stage of gate driving unit, and the first node Q(i), respectively; the stage transmission signal received by the second inverter covers the same waveform width range as the signal at the first node Q(i), and the second inverter operates normally during the entire effective level of the signal at the first node Q(i), thereby ensuring the output performance of the gate driving circuit.

As the dedicated signal in the gate driving unit, the stage transmission signal is not affected by the signals in the display area of the display panel, and the control signal received by the second inverter is more stable. The second inverter, which is controlled by both the stage transmission signal and the signal at the first node Q(i), has stronger stability; when either of the stage transmission signal and the signal at the first node Q(i) fails, the second inverter still works normally, and the reliability of the gate driving circuit is improved by means of the input of the single stage transmission signal or the single signal at the first node Q(i).

Channel widths of the twenty-third transistor T63, the twenty-fourth transistor T64, the twenty-fifth transistor T65, the twenty-sixth transistor T66, and the twenty-seventh transistor T67 are greater than a channel width of the twenty-second transistor T62, and the channel width of the twenty-second transistor T62 is greater than a channel width of the twenty-first transistor T61. Such a size configuration enables the second inverter to output a waveform with high reliability, which improves the stability of the gate driving circuit. The channel widths of the twenty-third transistor T63, the twenty-fourth transistor T64, the twenty-fifth transistor T65, the twenty-sixth transistor T66, and the twenty-seventh transistor T67 are relatively large, so that these transistors have a stronger current driving capability when being turned on, so that the potential of the third node K(i) drops faster, and the response speed of the second inverter is faster. The channel width of the twenty-second transistor T62 is moderate, so that the twenty-second transistor T62 has an appropriate current driving capability when being turned on, which not only ensures the dropping speed of the potential of the third node K(i), but also avoids the increase in area caused by the excessive channel width of the twenty-second transistor T62. The channel width of the twenty-first transistor T61 is relatively small, so that the twenty-first transistor T61 has a weak current driving capability when being turned on, which ensures the potential of the third node K(i) to rise slowly, thereby avoiding the malfunction of the second inverter caused by the potential of the third node K(i) rising too fast.

In an embodiment, the width W1 of the effective pulse of the stage-transmission signal output by the stage-transmission signal output terminal ST(i−a) of the (i−a)-th stage of gate driving unit, the width W2 of the effective pulse of the stage-transmission signal output by the stage-transmission signal output terminal ST(i−b) of the (i−b)-th stage of gate driving unit, the width W3 of the effective pulse of the stage-transmission signal output by the stage-transmission signal output terminal ST(i) of the i-th stage of gate driving unit, and the width W4 of the effective pulse of the stage-transmission signal output by the stage-transmission signal output terminal ST(i+c) of the (i+c)-th stage of gate driving unit are all less than the width W5 of the effective pulse of the signal transmitted by the first node Q(i); and the sum (W1+W2+W3+W4) of the width W1 of the effective pulse of the stage-transmission signal output by the stage-transmission signal output terminal ST(i−a) of the (i−a)-th stage of gate driving unit, the width W2 of the effective pulse of the stage-transmission signal output by the stage-transmission signal output terminal ST(i−b) of the (i−b)-th stage of gate driving unit, the width W3 of the effective pulse of the stage-transmission signal output by the stage-transmission signal output terminal ST(i) of the i-th stage of gate driving unit, and the width W4 of the effective pulse of the stage-transmission signal output by the stage-transmission signal output terminal ST(i+c) of the (i+c)-th stage of gate driving unit is greater than the width W5 of the effective pulse of the signal transmitted by the first node Q(i).

The first inverter and the second inverter work alternately. When the first control signal line LC1 outputs a high-level signal, the first inverter works and the second inverter does not work; and when the second control signal line LC2 outputs a high-level signal, the second inverter works and the first inverter does not work. The first inverter and the second inverter operate alternately, which avoids performance degradation caused by long-term operation of one single inverter and improves the service life of the gate driving circuit. The first inverter and the second inverter work alternately, so that the working time of each inverter is halved, thereby reducing the stress time of the thin film transistors, reducing the threshold voltage drift of the thin film transistors, and improving the stability of the gate driving circuit.

Embodiments of the present disclosure also provide a driving method of a display device. The display device includes a display panel, the display panel includes at least one gate driving circuit and a plurality of pixel units PX, the plurality of pixel units PX include 2N rows of pixel units PX, and the gate driving circuit includes N stages of gate driving units. An i-th stage of gate driving unit is electrically connected to a gate line SCAN of a (2i−1)-th row of pixel units PX and a gate line SCAN of a 2i-th row of pixel units PX. The i-th stage of gate driving unit includes a pull-up unit 102, and the pull-up unit 102 includes a first transistor T21 and a second transistor T23. A gate of the first transistor T21 and a gate of the second transistor T23 are both electrically connected to a first node Q(i), one of a source and a drain of the first transistor T21 is electrically connected to a first clock signal line CK(j), another one of the source and the drain of the first transistor T21 is electrically connected to a first gate driving signal output terminal G(2i−1), one of a source and a drain of the second transistor T23 is electrically connected to a second clock signal line CK(j+1), and another one of the source and the drain of the second transistor T23 is electrically connected to a second gate driving signal output terminal G(2i), where i and N are positive integers, and i is less than or equal to N.

The driving method includes that: when the first node Q(i) is in a high-potential state, the first transistor T21 is turned on, the first clock signal transmitted by the first clock signal line CK(j) is transmitted to the first gate driving signal output terminal G(2i−1) through the first transistor T21, the second transistor T23 is turned on, the second clock signal transmitted by the second clock signal line CK(j+1) is transmitted to the second gate driving signal output terminal G(2i) through the second transistor T23, and the output time of the effective level of the first clock signal and the output time of the effective level of the second clock signal are different.

The i-th stage of gate driving unit further includes a pull-down maintaining unit 104, the pull-down maintaining unit 104 includes a first inverter and a second inverter, and each of the first inverter and the second inverter includes a plurality of transistors electrically connected to stage-transmission signal output terminals at different stages. A width of an effective pulse of any one of the stage transmission signals output by the stage-transmission signal output terminals at different stages is less than a width of an effective pulse of the signal transmitted by the first node Q(i), and a sum of the widths of the effective pulses of the stage transmission signals output by the stage-transmission signal output terminals at different stages is greater than the width of the effective pulse of the signal transmitted by the first node Q(i).

Each of the first inverter and the second inverter includes four transistors electrically connected to the stage-transmission signal output terminal ST(i−a) of the (i−a)-th stage of gate driving unit, the stage-transmission signal output terminal ST(i−b) of the (i−b)-th stage of gate driving unit, the stage-transmission signal output terminal ST(i) of the i-th stage of gate driving unit and the stage-transmission signal output terminal ST(i+c) of the (i+c)-th stage of gate driving unit, respectively.

In an embodiment, the width W1 of the effective pulse of the stage-transmission signal output by the stage-transmission signal output terminal ST(i−a) of the (i−a)-th stage of gate driving unit, the width W2 of the effective pulse of the stage-transmission signal output by the stage-transmission signal output terminal ST(i−b) of the (i−b)-th stage of gate driving unit, the width W3 of the effective pulse of the stage-transmission signal output by the stage-transmission signal output terminal ST(i) of the i-th stage of gate driving unit, and the width W4 of the effective pulse of the stage-transmission signal output by the stage-transmission signal output terminal ST(i+c) of the (i+c)-th stage of gate driving unit are all less than the width W5 of the effective pulse of the signal transmitted by the first node Q(i); and the sum (W1+W2+W3+W4) of the width W1 of the effective pulse of the stage-transmission signal output by the stage-transmission signal output terminal ST(i−a) of the (i−a)-th stage of gate driving unit, the width W2 of the effective pulse of the stage-transmission signal output by the stage-transmission signal output terminal ST(i−b) of the (i−b)-th stage of gate driving unit, the width W3 of the effective pulse of the stage-transmission signal output by the stage-transmission signal output terminal ST(i) of the i-th stage of gate driving unit, and the width W4 of the effective pulse of the stage-transmission signal output by the stage-transmission signal output terminal ST(i+c) of the (i+c)-th stage of gate driving unit is greater than the width W5 of the effective pulse of the signal transmitted by the first node Q(i).

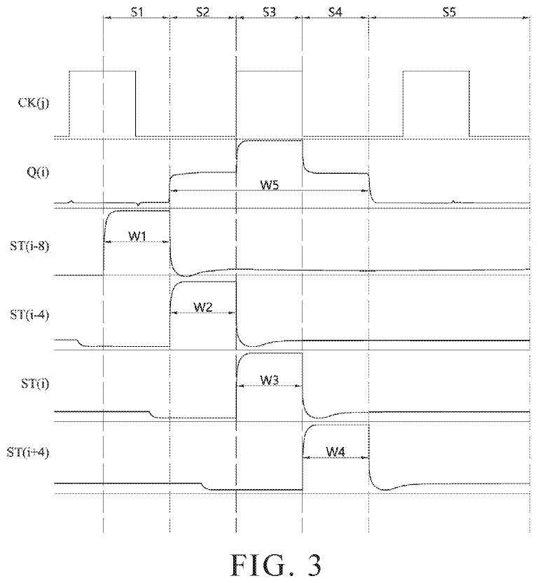

As shown in FIG. 3, a driving period of one frame image displayed by the display panel includes a first time period S1, a second time period S2, a third time period S3, a fourth time period S4, and a fifth time period S5.

The driving method further includes that: in the first time period S1, a stage-transmission signal output terminal ST(i−a) of an (i−a)-th stage of gate driving unit outputs a high-level signal, a stage-transmission signal output terminal ST(i−b) of an (i−b)-th stage of gate driving unit outputs a low-level signal, the stage-transmission signal output terminal ST(i) of the i-th stage of gate driving unit outputs a low-level signal, a stage-transmission signal output terminal ST(i+c) of an (i+c)-th stage of gate driving unit outputs a low-level signal, and the potential of the first node Q(i) is a first potential; in the second time period S2, the stage-transmission signal output terminal ST(i−a) of the (i−a)-th stage of gate driving unit outputs a low-level signal, the stage-transmission signal output terminal ST(i−b) of the (i−b)-th stage of gate driving unit outputs a high-level signal, the stage-transmission signal output terminal ST(i) of the i-th stage of gate driving unit outputs a low-level signal, the stage-transmission signal output terminal ST(i+c) of the (i+c)-th stage of gate driving unit outputs a low-level signal, the potential of the first node Q(i) is a second potential, and the second potential is greater than the first potential; in the third time period S3, the stage-transmission signal output terminal ST(i−a) of the (i−a)-th stage of gate driving unit outputs a low-level signal, the stage-transmission signal output terminal ST(i−b) of the (i−b)-th stage of gate driving unit outputs a low-level signal, the stage-transmission signal output terminal ST(i) of the i-th stage of gate driving unit outputs a high-level signal, the stage-transmission signal output terminal ST(i+c) of the (i+c)-th stage of gate driving unit outputs a low-level signal, the potential of the first node Q(i) is a third potential, and the third potential is greater than the second potential; in the fourth time period S4, the stage-transmission signal output terminal ST(i−a) of the (i−a)-th stage of gate driving unit outputs a low-level signal, the stage-transmission signal output terminal ST(i−b) of the (i−b)-th stage of gate driving unit outputs a low-level signal, the stage-transmission signal output terminal ST(i) of the i-th stage of gate driving unit outputs a low-level signal, the stage-transmission signal output terminal ST(i+c) of the (i+c)-th stage of gate driving unit outputs a high-level signal, and the potential of the first node Q(i) is the second potential; and in the fifth time period S5, the stage-transmission signal output terminal ST(i−a) of the (i−a)-th stage of gate driving unit outputs a low-level signal, the stage-transmission signal output terminal ST(i−b) of the (i−b)-th stage of gate driving unit outputs a low-level signal, the stage-transmission signal output terminal ST(i) of the i-th stage of gate driving unit outputs a low-level signal, the stage-transmission signal output terminal ST(i+c) of the (i+c)-th stage of gate driving unit outputs a low-level signal, and the potential of the first node Q(i) is the first potential, where a, b, and c are positive integers.

In the second time period S2, the potential of the first node Q(i) is the second potential, in the third time period S3, the potential of the first node Q(i) is the third potential, in the fourth time period S4, the potential of the first node Q(i) is the second potential, and the second potential and the third potential are both high potentials; the first transistor T21 and the second transistor T23 are turned on in the second time period S2, the third time period S3, and the fourth time period S4; the first clock signal transmitted by the first clock signal line CK(j) is transmitted to the first gate driving signal output terminal G(2i−1) through the first transistor T21, and the second clock signal transmitted by the second clock signal line CK(j+1) is transmitted to the second gate driving signal output terminal G(2i) through the second transistor T23. Since the output time of the effective level of the first clock signal is different from the output time of the effective level of the second clock signal, the first gate driving signal output terminal G(2i−1) and the second gate driving signal output terminal G(2i) output the effective levels at different times, thereby realizing the function of outputting two gate driving signals by one stage of gate driving unit.

The i-th stage of gate driving unit further includes a reset unit 103, and the reset unit 103 is electrically connected to the first node Q(i), the first gate driving signal output terminal G(2i−1), the second gate driving signal output terminal G(2i), and the stage-transmission signal output terminal ST(i). The driving method further includes that: in a reset phase, the reset unit 103 pulls down potentials of the first node Q(i), the first gate driving signal output terminal G(2i−1), the second gate driving signal output terminal G(2i), and the stage-transmission signal output terminal ST(i) to low-potential states.

TABLE 1

| Verification Object | | 22 FHD |
|---|---|---|
| Number of Clock Signal Lines | | 12 to 16 |
| Duty Cycle of Clock Signal | | 40% to 44% |
| Voltage of First Power Signal Line | | 25 V to 30 V |
| Verification Criteria | | Verification Results |
| Positive Shift Margin | Not up to standard when | 7 V |
| of Threshold Voltage | greater than 5 volts | |
| Negative Shift Margin | Not up to standard when | −7 V |
| of Threshold Voltage | less than −4 volts | |
| Reliability Verification | Up to Standard | Up to Standard |
| of Transistor | | |
| Electrical Offset | | |
| Verification of Electrical | Up to Standard | Up to Standard |
| Parameter Table at 80 | | |
| Degrees Celsius | | |
| Verification of Electrical | Up to Standard | Up to Standard |
| Parameter Table at −20 | | |
| Degrees Celsius | | |
| Voltage Margin of First | Not up to standard | Not up to standard |
| Power Signal Line | when less than 10 Volts | when equal to 5 |
| | | volts |

As shown in Table 1, the display device provided in the embodiments of the present disclosure is verified on a 22-inch full-high-definition resolution display panel. The number of the clock signal lines ranges from 12 to 16, the duty cycle of the clock signal ranges from 40% to 44%, the voltage transmitted by the first power signal line VGH ranges from 25 volts to 30 volts, the positive shift margin of the threshold voltage is 7 volts, which is greater than a determination standard of 5 volts, the negative shift margin of the threshold voltage is −7 volts, which is less than a determination standard of −4 volts, the reliability verification of the electrical offset of the transistor passes, the reliability verification of the electrical offset of the transistor plus 3 volts passes, the verification of the electrical parameter table at 80 degrees Celsius passes, the verification of the electrical parameter table at −20 degrees Celsius passes, and the voltage margin of the first power signal line VGH is 5 volts, which is less than a determination standard of 10 volts. The verification results show that the technical solutions in the present disclosure reduce a frame width of the display panel while maintaining the same reliability as the traditional gate driving unit, and meet the requirement of the narrow frame display panel.

Compared with that 32 thin film transistors are included in two stages of gate driving units outputting gate driving signals for driving two rows of pixel units PX in a traditional gate driving circuit, in technical solutions of the present disclosure, one stage of gate driving unit in the present disclosure includes 31 thin film transistors, which saves one thin film transistor and improves reliability. Compared with that 40 thin film transistors or more are included in two stages of gate driving units outputting gate driving signals for driving two rows of pixel units PX in the traditional gate driving circuit with high reliability, on the premise of meeting the same reliability requirement, the technical solutions in the present disclosure save at least 9 thin film transistors, reduce the occupied area of the gate driving circuit, and meet the requirement of a narrow frame display panel.

The foregoing describes the embodiments of the present disclosure in detail, and content of the specification should not be understood as a limitation on the protection scope of the present disclosure.

What is claimed is:

1. A display device, comprising a display panel, wherein the display panel comprises at least one gate driving circuit and a plurality of pixel units, the plurality of pixel units comprise 2N rows of pixel units, the gate driving circuit comprises N stages of gate driving units, and an i-th stage of gate driving unit is electrically connected to a gate line of a (2i−1)-th row of pixel units and a gate line of a 2i-th row of pixel units;
wherein the i-th stage of gate driving unit comprises:
a pull-up control unit configured to control a potential of a first node;
a pull-up unit comprising a first transistor and a second transistor, wherein a gate of the first transistor is electrically connected to the first node, one of a source and a drain of the first transistor is electrically connected to a first clock signal line, and another one of the source and the drain of the first transistor is electrically connected to a first gate driving signal output terminal; and a gate of the second transistor is electrically connected to the first node, one of a source and a drain of the second transistor is electrically connected to a second clock signal line, and another one of the source and the drain of the second transistor is electrically connected to a second gate driving signal output terminal; and
a pull-down maintaining unit comprising at least two inverters, wherein the inverters are electrically connected to a stage-transmission signal output terminal of the i-th stage of gate driving unit, the first node, the first gate driving signal output terminal, and the second gate driving signal output terminal; and
wherein i and N are positive integers, and i is less than or equal to N.

2. The display device according to claim 1, wherein the pull-up control unit comprises a third transistor, a gate of the third transistor is electrically connected to a stage-transmission signal output terminal of an (i−x)-th stage of gate driving unit, one of a source and a drain of the third transistor is electrically connected to a first power signal line or the stage-transmission signal output terminal of the (i−x)-th stage of gate driving unit, and another one of the source and the drain of the third transistor is electrically connected to the first node; wherein x is a positive integer.

3. The display device according to claim 2, wherein x is half of a number of clock signal lines of the gate driving circuit.

4. The display device according to claim 1, wherein the pull-up unit further comprises a fourth transistor, a gate of the fourth transistor is electrically connected to the first node, one of a source and a drain of the fourth transistor is electrically connected to the first clock signal line, and another one of the source and the drain of the fourth transistor is electrically connected to the stage-transmission signal output terminal of the i-th stage of gate driving unit.

5. The display device according to claim 1, wherein the i-th stage of gate driving unit further comprises a reset unit; the reset unit comprises a fifth transistor, a sixth transistor, a seventh transistor, and an eighth transistor; a gate of the fifth transistor is electrically connected to a reset control signal line, one of a source and a drain of the fifth transistor is electrically connected to a second power signal line, and another one of the source and the drain of the fifth transistor is electrically connected to the first node; a gate of the sixth transistor is electrically connected to the reset control signal line, one of a source and a drain of the sixth transistor is electrically connected to the second power signal line, and another one of the source and the drain of the sixth transistor is electrically connected to the stage-transmission signal output terminal of the i-th stage of gate driving unit; a gate of the seventh transistor is electrically connected to the reset control signal line, one of a source and a drain of the seventh transistor is electrically connected to a third power signal line, and another one of the source and the drain of the seventh transistor is electrically connected to the first gate driving signal output terminal; and a gate of the eighth transistor is electrically connected to the reset control signal line, one of a source and a drain of the eighth transistor is electrically connected to the third power signal line, and another one of the source and the drain of the eighth transistor is electrically connected to the second gate driving signal output terminal.

6. The display device according to claim 1, wherein the i-th stage of gate driving unit further comprises a pull-down unit, the pull-down unit comprises a ninth transistor, a gate of the ninth transistor is electrically connected to a stage-transmission signal output terminal of an (i+y)-th stage of gate driving unit, one of a source and a drain of the ninth transistor is electrically connected to a second power signal line, and another one of the source and the drain of the ninth transistor is electrically connected to the first node; wherein y is a positive integer.

7. The display device according to claim 1, wherein the at least two inverters comprise a first inverter and a second inverter, each of the first inverter and the second inverter comprises a plurality of transistors electrically connected to stage-transmission signal output terminals at different stages, a width of an effective pulse of any one of stage transmission signals output by the stage-transmission signal output terminals at different stages is less than a width of an effective pulse of a signal transmitted by the first node, and a sum of widths of effective pulses of the stage transmission signals output by the stage-transmission signal output terminals at different stages is greater than the width of the effective pulse of the signal transmitted by the first node.

8. The display device according to claim 7, wherein the first inverter comprises a tenth transistor, an eleventh transistor, a twelfth transistor, a thirteenth transistor, a fourteenth transistor, a fifteenth transistor, and a sixteenth transistor;
wherein the pull-down maintaining unit further comprises a seventeenth transistor, an eighteenth transistor, a nineteenth transistor, and a twentieth transistor; and
wherein a gate of the tenth transistor is electrically connected to a first control signal line, one of a source and a drain of the tenth transistor is electrically connected to the first control signal line, and another one of the source and the drain of the tenth transistor is electrically connected to a second node; a gate of the eleventh transistor is electrically connected to a second control signal line, one of a source and a drain of the eleventh transistor is electrically connected to a second power signal line, and another one of the source and the drain of the eleventh transistor is electrically connected to the second node; a gate of the twelfth transistor is electrically connected to a stage-transmission signal output terminal of an (i−a)-th stage of gate driving unit, one of a source and a drain of the twelfth transistor is electrically connected to the second power signal line, and another one of the source and the drain of the twelfth transistor is electrically connected to the second node; a gate of the thirteenth transistor is electrically connected to a stage-transmission signal output terminal of an (i−b)-th stage of gate driving unit, one of a source and a drain of the thirteenth transistor is electrically connected to the second power signal line, and another one of the source and the drain of the thirteenth transistor is electrically connected to the second node; a gate of the fourteenth transistor is electrically connected to the stage-transmission signal output terminal of the i-th stage of gate driving unit, one of a source and a drain of the fourteenth transistor is electrically connected to the second power signal line, and another one of the source and the drain of the fourteenth transistor is electrically connected to the second node; a gate of the fifteenth transistor is electrically connected to a stage-transmission signal output terminal of an (i+c)-th stage of gate driving unit, one of a source and a drain of the fifteenth transistor is electrically connected to the second power signal line, and another one of the source and the drain of the fifteenth transistor is electrically connected to the second node; a gate of the sixteenth transistor is electrically connected to the first node, one of a source and a drain of the sixteenth transistor is electrically connected to the second power signal line, and another one of the source and the drain of the sixteenth transistor is electrically connected to the second node; a gate of the seventeenth transistor is electrically connected to the second node, one of a source and a drain of the seventeenth transistor is electrically connected to a third power signal line, and another one of the source and the drain of the seventeenth transistor is electrically connected to the first gate driving signal output terminal; a gate of the eighteenth transistor is electrically connected to the second node, a source and a drain of the eighteenth transistor is electrically connected to the second power signal line, and another one of the source and the drain of the eighteenth transistor is electrically connected to the stage-transmission signal output terminal of the i-th stage of gate driving unit; a gate of the nineteenth transistor is electrically connected to the second node, one of a source and a drain of the nineteenth transistor is electrically connected to the second power signal line, and another one of the source and the drain of the nineteenth transistor is electrically connected to the first node; and a gate of the twentieth transistor is electrically connected to the second node, one of a source and a drain of the twentieth transistor is electrically connected to the third power signal line, and another one of the source and the drain of the twentieth transistor is electrically connected to the second gate driving signal output terminal; wherein a, b, and c are positive integers.

9. The display device according to claim 8, wherein channel widths of the twelfth transistor, the thirteenth transistor, the fourteenth transistor, the fifteenth transistor, and the sixteenth transistor are greater than a channel width of the eleventh transistor, and the channel width of the eleventh transistor is greater than a channel width of the tenth transistor.

10. The display device according to claim 7, wherein the second inverter comprises a twenty-first transistor, a twenty-second transistor, a twenty-third transistor, a twenty-fourth transistor, a twenty-fifth transistor, a twenty-sixth transistor, and a twenty-seventh transistor;
wherein the pull-down maintaining unit further comprises a twenty-eighth transistor, a twenty-ninth transistor, a thirtieth transistor, and a thirty-first transistor; and
wherein a gate of the twenty-first transistor is electrically connected to a second control signal line, one of a source and a drain of the twenty-first transistor is electrically connected to the second control signal line, and another one of the source and the drain of the twenty-first transistor is electrically connected to a third node; a gate of the twenty-second transistor is electrically connected to a first control signal line, one of a source and a drain of the twenty-second transistor is electrically connected to a second power signal line, and another one of the source and the drain of the twenty-second transistor is electrically connected to the third node; a gate of the twenty-third transistor is electrically connected to a stage-transmission signal output terminal of an (i−a)-th stage of gate driving unit, one of a source and a drain of the twenty-third transistor is electrically connected to the second power signal line, and another one of the source and the drain of the twenty-third transistor is electrically connected to the third node; a gate of the twenty-fourth transistor is electrically connected to a stage-transmission signal output terminal of an (i−b)-th stage of gate driving unit, one of a source and a drain of the twenty-fourth transistor is electrically connected to the second power signal line, and another one of the source and the drain of the twenty-fourth transistor is electrically connected to the third node; a gate of the twenty-fifth transistor is electrically connected to the stage-transmission signal output terminal of the i-th stage of gate driving unit, one of a source and a drain of the twenty-fifth transistor is electrically connected to the second power signal line, and another one of the source and the drain of the twenty-fifth transistor is electrically connected to the third node; a gate of the twenty-sixth transistor is electrically connected to a stage-transmission signal output terminal of an (i+c)-th stage of gate driving unit, one of a source and a drain of the twenty-sixth transistor is electrically connected to the second power signal line, and another one of the source and the drain of the twenty-sixth transistor is electrically connected to the third node; a gate of the twenty-seventh transistor is electrically connected to the first node, one of a source and a drain of the twenty-seventh transistor is electrically connected to the second power signal line, and another one of the source and the drain of the twenty-seventh transistor is electrically connected to the third node; a gate of the twenty-eighth transistor is electrically connected to the third node, one of a source and a drain of the twenty-eighth transistor is electrically connected to a third power signal line, and another one of the source and the drain of the twenty-eighth transistor is electrically connected to the first gate driving signal output terminal; a gate of the twenty-ninth transistor is electrically connected to the third node, one of a source and a drain of the twenty-ninth transistor is electrically connected to the second power signal line, and another one of the source and the drain of the twenty-ninth transistor is electrically connected to the stage-transmission signal output terminal of the i-th stage of gate driving unit; a gate of the thirtieth transistor is electrically connected to the third node, one of a source and a drain of the thirtieth transistor is electrically connected to the second power signal line, and another one of the source and the drain of the thirtieth transistor is electrically connected to the first node; and a gate of the thirty-first transistor is electrically connected to the third node, one of a source and a drain of the thirty-first transistor is electrically connected to the third power signal line, and another one of the source and the drain of the thirty-first transistor is electrically connected to the second gate driving signal output terminal; wherein a, b, and c are positive integers.

11. The display device according to claim 10, wherein channel widths of the twenty-third transistor, the twenty-fourth transistor, the twenty-fifth transistor, the twenty-sixth transistor, and the twenty-seventh transistor are greater than a channel width of the twenty-second transistor, and the channel width of the twenty-second transistor is greater than a channel width of the twenty-first transistor.

12. The display device according to claim 1, wherein the first gate driving signal output terminal is electrically connected to the gate line of the (2i−1)-th row of pixel units, and the second gate driving signal output terminal is electrically connected to the gate line of the 2i-th row of pixel units.

13. The display device according to claim 1, wherein the pull-up unit further comprises a first capacitor, a first electrode plate of the first capacitor is electrically connected to the first node, and a second electrode plate of the first capacitor is electrically connected to the first gate driving signal output terminal; and/or the pull-up unit further comprises a second capacitor, a first electrode plate of the second capacitor is electrically connected to the first node, and a second electrode plate of the second capacitor is electrically connected to the second gate driving signal output terminal.

14. The display device according to claim 1, wherein transistors in the i-th stage of gate driving unit are oxide semiconductor thin film transistors.

15. A driving method of a display device, wherein the display device comprises a display panel, the display panel comprises at least one gate driving circuit and a plurality of pixel units, the plurality of pixel units comprise 2N rows of pixel units, the gate driving circuit comprises N stages of gate driving units, and an i-th stage of gate driving unit is electrically connected to a gate line of a (2i−1)-th row of pixel units and a gate line of a 2i-th row of pixel units; the i-th stage of gate driving unit comprises a pull-up unit, the pull-up unit comprises a first transistor and a second transistor, a gate of the first transistor and a gate of the second transistor are both electrically connected to a first node, one of a source and a drain of the first transistor is electrically connected to a first clock signal line, another one of the source and the drain of the first transistor is electrically connected to a first gate driving signal output terminal, one of a source and a drain of the second transistor is electrically connected to a second clock signal line, and another one of the source and the drain of the second transistor is electrically connected to a second gate driving signal output terminal;
wherein the driving method comprises that:
when the first node is in a high-potential state, the first transistor is turned on, a first clock signal transmitted by the first clock signal line is transmitted to the first gate driving signal output terminal through the first transistor, the second transistor is turned on, a second clock signal transmitted by the second clock signal line is transmitted to the second gate driving signal output terminal through the second transistor, and an output time of an effective level of the first clock signal is different from an output time of an effective level of the second clock signal; and
wherein i and N are positive integers, and i is less than or equal to N.

16. The driving method according to claim 15, wherein the i-th stage of gate driving unit further comprises a pull-down maintaining unit, the pull-down maintaining unit comprises a first inverter and a second inverter, each of the first inverter and the second inverter comprises a plurality of transistors electrically connected to stage-transmission signal output terminals at different stages, a width of an effective pulse of any one of the stage transmission signals output by the stage-transmission signal output terminals at different stages is less than a width of an effective pulse of the signal transmitted by the first node, and a sum of widths of effective pulses of the stage transmission signals output by the stage-transmission signal output terminals at different stages is greater than the width of the effective pulse of the signal transmitted by the first node.

17. The driving method according to claim 16, wherein each of the first inverter and the second inverter comprises four transistors electrically connected to a stage-transmission signal output terminal of an (i−a)-th stage of gate driving unit, a stage-transmission signal output terminal of an (i−b)-th stage of gate driving unit, the stage-transmission signal output terminal of the i-th stage of gate driving unit, and a stage-transmission signal output terminal of an (i+c)-th stage of gate driving unit, respectively.

18. The driving method according to claim 17, wherein a width of an effective pulse of a stage-transmission signal output by the stage-transmission signal output terminal of the (i−a)-th stage of gate driving unit, a width of an effective pulse of a stage-transmission signal output by the stage-transmission signal output terminal of the (i−b)-th stage of gate driving unit, a width of an effective pulse of a stage-transmission signal output by the stage-transmission signal output terminal of the i-th stage of gate driving unit, and a width of an effective pulse of a stage-transmission signal output by the stage-transmission signal output terminal of the (i+c)-th stage of gate driving unit are all less than a width of an effective pulse of a signal transmitted by the first node; and
a sum of the width of the effective pulse of the stage-transmission signal output by the stage-transmission signal output terminal of the (i−a)-th stage of gate driving unit, the width of the effective pulse of the stage-transmission signal output by the stage-transmission signal output terminal of the (i−b)-th stage of gate driving unit, the width of the effective pulse of the stage-transmission signal output by the stage-transmission signal output terminal of the i-th stage of gate driving unit, and the width of the effective pulse of the stage-transmission signal output by the stage-transmission signal output terminal of the (i+c)-th stage of gate driving unit is greater than the width of the effective pulse of the signal transmitted by the first node.

19. The driving method according to claim 17, wherein a driving period of one frame image comprises a first time period, a second time period, a third time period, a fourth time period, and a fifth time period; and
the driving method further comprises that:
in the first time period, a stage-transmission signal output terminal of an (i−a)-th stage of gate driving unit outputs a high-level signal, a stage-transmission signal output terminal of an (i−b)-th stage of gate driving unit outputs a low-level signal, the stage-transmission signal output terminal of the i-th stage of gate driving unit outputs a low-level signal, a stage-transmission signal output terminal of an (i+c)-th stage of gate driving unit outputs a low-level signal, and the potential of the first node is a first potential;
in the second time period, the stage-transmission signal output terminal of the (i−a)-th stage of gate driving unit outputs a low-level signal, the stage-transmission signal output terminal of the (i−b)-th stage of gate driving unit outputs a high-level signal, the stage-transmission signal output terminal of the i-th stage of gate driving unit outputs a low-level signal, the stage-transmission signal output terminal of the (i+c)-th stage of gate driving unit outputs a low-level signal, the potential of the first node is a second potential, and the second potential is greater than the first potential;
in the third time period, the stage-transmission signal output terminal of the (i−a)-th stage of gate driving unit outputs a low-level signal, the stage-transmission signal output terminal of the (i−b)-th stage of gate driving unit outputs a low-level signal, the stage-transmission signal output terminal of the i-th stage of gate driving unit outputs a high-level signal, the stage-transmission signal output terminal of the (i+c)-th stage of gate driving unit outputs a low-level signal, the potential of the first node is a third potential, and the third potential is greater than the second potential;
in the fourth time period, the stage-transmission signal output terminal of the (i−a)-th stage of gate driving unit outputs a low-level signal, the stage-transmission signal output terminal of the (i−b)-th stage of gate driving unit outputs a low-level signal, the stage-transmission signal output terminal of the i-th stage of gate driving unit outputs a low-level signal, the stage-transmission signal output terminal of the (i+c)-th stage of gate driving unit outputs a high-level signal, and the potential of the first node is the second potential; and
in the fifth time period, the stage-transmission signal output terminal of the (i−a)-th stage of gate driving unit outputs a low-level signal, the stage-transmission signal output terminal of the (i−b)-th stage of gate driving unit outputs a low-level signal, the stage-transmission signal output terminal of the i-th stage of gate driving unit outputs a low-level signal, the stage-transmission signal output terminal of the (i+c)-th stage of gate driving unit outputs a low-level signal, and the potential of the first node is the first potential, where a, b, and c are positive integers.

20. The driving method according to claim 15, wherein the i-th stage of gate driving unit further comprises a reset unit, and the reset unit is electrically connected to the first node, the first gate driving signal output terminal, the second gate driving signal output terminal, and a stage-transmission signal output terminal; and
the driving method further comprises that: in a reset phase, the reset unit pulls down potentials of the first node, the first gate driving signal output terminal, the second gate driving signal output terminal, and the stage-transmission signal output terminal to low-potential states.
